(19) United States
(12) Patent Application Publication
(10) Pub. No.: US 2023/0334596 A1
(43) Pub. Date: Oct. 19, 2023

(54) MULTIMEDIA PROCESSING METHOD, APPARATUS AND DEVICE, AND MEDIUM

(71) Applicant: TENCENT TECHNOLOGY (SHENZHEN) COMPANY LIMITED, Shenzhen (CN)

(72) Inventors: Ruijie JIANG, Shenzhen (CN); Guilin XIANG, Shenzhen (CN)

(21) Appl. No.: 18/213,620

(22) Filed: Jun. 23, 2023

Related U.S. Application Data
(63) Continuation of application No. PCT/CN2022/127855, filed on Oct. 27, 2022.

(30) Foreign Application Priority Data
Jan. 4, 2022 (CN) 202210007959.2

(51) Int. Cl. G06Q 50/00; H04L 51/046; H04L 51/10; H04L 51/52; G06F 3/0482; G06F 3/0488

(52) U.S. Cl. CPC G06Q 50/01; H04L 51/046; H04L 51/10; H04L 51/52; G06F 3/0482; G06F 3/0488

(57) ABSTRACT

A multimedia processing method includes: displaying a social media page, the social media page including a multimedia displayed in a first form, and the first form indicating that the multimedia is in an unrecognized state; displaying the multimedia in a second form in response to the multimedia in the first form being triggered, the second form indicating that an associated page of the multimedia has been searched, and page content of the associated page being matched with a multimedia content of the multimedia; and displaying the associated page in response to that the multimedia in the second form is triggered.

### CROSS-REFERENCES TO RELATED APPLICATIONS

This application is a continuation application of PCT Patent Application No. PCT/CN2022/127855, filed on Oct. 27, 2023, which claims priority to Chinese Patent Application No. 202210007959.2, filed to the China Patent Office on Jan. 4, 2022 and entitled “MULTIMEDIA PROCESSING METHOD, APPARATUS, AND DEVICE, MEDIUM, AND COMPUTER PROGRAM PRODUCT”, the entire contents of both of which are incorporated herein by reference.

### FIELD OF THE TECHNOLOGY

The present disclosure relates to the technical field of computers, and in particular to a multimedia processing method, apparatus and device, a medium, and a computer program product.

### BACKGROUND

By virtue of a social application, a user can carry out social activities and information interaction through a network. For example, the user can carry out social activities such as information exchange (instant messaging), news sharing and online state sharing and transmit multimedia, such as a text, am image, an audio, a video, and a document, by virtue of the social application so that information interaction between the users is achieved. Due to the complexity of multimedia, how to improve the efficiency of information acquisition in social scenarios becomes a current research hotspot.

### SUMMARY

Embodiments of the present disclosure provide a multimedia processing method, apparatus and device, a medium, and a computer program product, by which the efficiency and convenience of information acquisition in social scenarios can be improved.

In one aspect, an embodiment of the present disclosure provides a multimedia processing method, the method is performed by a computer device, and the method includes: displaying a social media page, the social media page including a multimedia displayed in a first form, and the first form indicating that the multimedia is in an unrecognized state; displaying the multimedia in a second form in response to the multimedia in the first form being triggered, the second form indicating that an associated page of the multimedia has been searched, and page content of the associated page being matched with a multimedia content of the multimedia; and displaying the associated page in response to that the multimedia in the second form is triggered.

In another aspect, an embodiment of the present disclosure provides a multimedia processing apparatus, the multimedia processing apparatus is deployed on a multimedia processing device, and the multimedia processing apparatus includes a processing unit and an output unit, wherein the processing unit and the output unit are configured to perform the above-mentioned multimedia processing method.

In further aspect, an embodiment of the present disclosure provides a multimedia processing device, the multimedia processing device includes an input interface and an output interface, and further includes: at least one processor configured to implement one or more instructions; and at least one computer storage medium having stored thereon one or more instructions, and the one or more instructions are loaded and executed by the at least one processor to implement the above-mentioned multimedia processing method.

In yet further aspect, an embodiment of the present disclosure provides a non-transitory computer storage medium having stored thereon a computer program instruction, and the computer program instruction, when being executed by at least one processor, causing the at least one processor to perform the above-mentioned multimedia processing method.

In the embodiments of the present disclosure, a multimedia in a first form is displayed in a social media page, wherein the first form indicates that the multimedia is in an unrecognized state. The multimedia is displayed in a second form in response to the multimedia in the first form being triggered, wherein the second form indicates that associated pages of the multimedia have been searched. The multimedia in the first form being triggered, which is described herein, means that the multimedia requires to further search relevant information, then, the multimedia in the first form can be recognized, associated pages can be searched based on a recognition result, and the multimedia is displayed in the second form to remind a user to view the searched associated pages. The associated pages are displayed in response to that the multimedia in the second form is triggered, so that the user can acquire more relevant information of the multimedia from the associated pages, and the efficiency and convenience of information acquisition in social scenarios can be effectively improved.

### BRIEF DESCRIPTION OF THE DRAWINGS

To describe the technical solutions in the embodiments of the present disclosure or the related art more clearly, accompanying drawings required for describing the embodiments or the related art are to be briefly introduced below. Apparently, the accompanying drawings in the following description show only some embodiments of the present disclosure.

FIG. 1 is a schematic structural diagram of a multimedia processing system in an embodiment of the present disclosure;

FIG. 2 is a schematic flowchart of a multimedia processing method in an embodiment of the present disclosure;

FIG. 3 is a schematic diagram of a chat page in an embodiment of the present disclosure;

FIG. 4 is a schematic diagram of a friend news page in an embodiment of the present disclosure;

FIG. 5 is a schematic diagram of a state label and a state description text in an embodiment of the present disclosure;

FIG. 6a is a schematic diagram of a state query page of a target social friend in an embodiment of the present disclosure;

FIG. 6b is a schematic diagram of an operation of triggering the display of the state query page of the target friend in an embodiment of the present disclosure;

FIG. 7 is a schematic diagram of a topic page in an embodiment of the present disclosure;

FIG. 8a is a schematic diagram of a multimedia including an interaction label and being in a second form in an embodiment of the present disclosure;

FIG. 8b is a schematic diagram of another multimedia including an interaction label and being in a second form in an embodiment of the present disclosure;

FIG. 8c is a schematic diagram of further multimedia including an interaction label and being in a second form in an embodiment of the present disclosure;

FIG. 8d is a schematic diagram of yet further multimedia including an interaction label and being in a second form in an embodiment of the present disclosure;

FIG. 9a is a schematic diagram of a multimedia including associated page trigger controls and being in a second form in an embodiment of the present disclosure;

FIG. 9b is a schematic diagram of another multimedia including associated page trigger controls and being in a second form in an embodiment of the present disclosure;

FIG. 9c is a schematic diagram of further multimedia including associated page trigger controls and being in a second form in an embodiment of the present disclosure;

FIG. 9d is a schematic diagram of yet further multimedia including associated page trigger controls and being in a second form in an embodiment of the present disclosure;

FIG. 10a is a schematic diagram of a multimedia including a plurality of associated page trigger controls and being in a second form in an embodiment of the present disclosure;

FIG. 10b is a schematic diagram of another multimedia including a plurality of associated page trigger controls and being in a second form in an embodiment of the present disclosure;

FIG. 10c is a schematic diagram of further multimedia including a plurality of associated page trigger controls and being in a second form in an embodiment of the present disclosure;

FIG. 11 is a schematic diagram of an operation of displaying page description information of associated pages based on the associated page trigger controls in an embodiment of the present disclosure;

FIG. 12a is a schematic diagram of an operation of triggering the display of the associated pages of the multimedia in an embodiment of the present disclosure;

FIG. 12b is a schematic diagram of an operation of triggering the display of the associated pages of the multimedia based on the interaction label in an embodiment of the present disclosure;

FIG. 12c is a schematic diagram of an operation of triggering the display of the associated pages of the multimedia based on the associated page trigger controls in an embodiment of the present disclosure;

FIG. 12d is a schematic diagram of an operation of displaying the associated pages based on a candidate list in an embodiment of the present disclosure;

FIG. 12e is a schematic diagram of an operation of triggering the display of the associated pages based on the plurality of associated page trigger controls in an embodiment of the present disclosure;

FIG. 13a is a schematic diagram of an operation of triggering the display of the associated pages of the multimedia on a social media page in an embodiment of the present disclosure;

FIG. 13b is a schematic diagram of another operation of triggering the display of the associated pages of the multimedia on a social media page in an embodiment of the present disclosure;

FIG. 13c is a schematic diagram of further operation of triggering the display of the associated pages of the multimedia in a social media page in an embodiment of the present disclosure;

FIG. 13d is a schematic diagram of yet further operation of triggering the display of the associated pages of the multimedia on a social media page in an embodiment of the present disclosure;

FIG. 14 is a schematic diagram of an operation of displaying the multimedia in the second form in the social media page in an embodiment of the present disclosure;

FIG. 15 is a schematic flowchart of another multimedia processing method in an embodiment of the present disclosure;

FIG. 16 is a schematic diagram of multi-dimensional recognition processing on the multimedia in an embodiment of the present disclosure;

FIG. 17 is a schematic diagram of confirmation of access link information in an embodiment of the present disclosure;

FIG. 18 is a schematic diagram of acquisition of the access link information of the associated pages based on a server in an embodiment of the present disclosure;

FIG. 19 is a schematic diagram of an operation of displaying the multimedia in the second form based on a label control in an embodiment of the present disclosure;

FIG. 20a is a schematic diagram of an operation of displaying the associated pages based on acquiring the access link information of the associated pages in an embodiment of the present disclosure;

FIG. 20b is a schematic diagram of another display of the associated pages based on acquiring the access link information of the associated pages in an embodiment of the present disclosure;

FIG. 21 is a schematic structural diagram of a multimedia processing apparatus in an embodiment of the present disclosure; and

FIG. 22 is a schematic structural diagram of a multimedia processing device in an embodiment of the present disclosure.

### DESCRIPTION OF EMBODIMENTS

The technical solutions in the embodiments of the present disclosure are to be described clearly and completely below in conjunction with the accompanying drawings in the embodiments of the present disclosure. Apparently, the described embodiments are a part of the embodiments of the present disclosure, not all the embodiments. Based on the embodiments of the present disclosure, all other embodiments obtained by those of ordinary skill in the art without creative work are to fall within the protective scope of the present disclosure.

Technical terms involved in the embodiments of the present disclosure are to be introduced as follows:

1. Social Application:

Narrowly speaking, a social application may refer to a social application corresponding to a server and providing a user with local service. The social application may include, but is not limited to an instant messaging APP, a map social APP, a content interaction APP, and a game social APP. Broadly speaking, the social application may further refer to a socially-competent website corresponding to a server and providing a user with local service, such as a social networking site and forum. A user can carry out social activities, such as information exchange (instant messaging), news sharing, and online state sharing, by virtue of the social application, and can transmit interactive multimedia in social activities, wherein the multimedia may include, but is not limited to a text, an image, an audio, a video, and a document.

2. Social Session:

The social application supports social session, and the social session may include separate session and group chat session. The separate session refers to social session in which two users participate and which is used to exchange information between the two users. The group chat session is social session in which a plurality of (more than two) users participate and which is used to exchange information among the plurality of users. The social session can also be referred to as a super community in response to that the number of people participating in the social session exceeds a threshold (such as 100,000).

3. Social Media Pages:

Social media pages may also be called social networking pages. The social application provides various social media pages which refer to pages presented in response to that the social application provides social service, and the social media pages may include, but are not limited to a chat page, a friend news page, a state query page, and a topic page. The chat page refers to a page for presenting a chat message of social session; and a user participating in the social session may publish a chat message in the chat page and browse chat messages published by other users, thereby realizing social communication. The friend news page refers to a page for viewing news of a social friend, and the news described herein refers to a way of publishing a temporary content which includes, but is not limited to music, a picture, a video, and a text. The state query page refers to a page for querying an online state of the social friend, and the online state described herein is used to describe a current state of the social friend, which includes, but is not limited to an online state, an offline state, music, watching TV, and running.

4. Mini Application:

The mini application is a light application that does not need to be downloaded or installed, and can achieve almost all functions of an APP. The mini application usually runs as a sub-application of a certain APP. For example, a social application may include a plurality of mini applications; and a payment APP may also include a plurality of mini applications.

In subsequent specific implementations of the present disclosure, data relevant to a chat message, a news, an online state, etc. of a user is involved. Permission or consent from the user is required in response to that the embodiments of the present disclosure are applied to a specific product or technology, and the collection, use and processing of relevant data are required to comply with relevant laws, regulations and standards of relevant countries and regions.

The social media page generally includes more multimedia which may be a picture, an audio, a video, etc. For example, a certain user sends a picture in a chat page; for another example, a certain user publishes a video news, etc. On this premise, a user requires to further search relevant information of a certain multimedia in response to that the user is interested in the multimedia; for example, the user is desired to find a restaurant, flight information, an electronic identity card, bank service, commodity service, etc. based on the multimedia. In order to satisfy the searching requirement and rapidly and conveniently acquire more information in social scenarios, an embodiment of the present disclosure provides the following multimedia processing solution: a multimedia in a first form is displayed in a social media page, wherein the first form described herein may refer to a form in which the multimedia is not recognized and searched, such as a picture which has been sent, but has not been recognized and searched in the chat page. The multimedia is displayed in a second form in response to the multimedia in the first form being triggered, wherein the second form indicates that associated pages of the multimedia have been searched. The multimedia in the first form being triggered, which is described herein, means that the multimedia requires to further search relevant information, then, a background may recognize the multimedia in the first form, search associated pages based on a recognition result, and display the multimedia in the second form to remind a user to view the searched associated pages. The associated pages are displayed in response to that the multimedia in the second form is triggered, so that the user can acquire more relevant information of the multimedia from the associated pages, and the efficiency and convenience of information acquisition in social scenarios can be effectively improved.

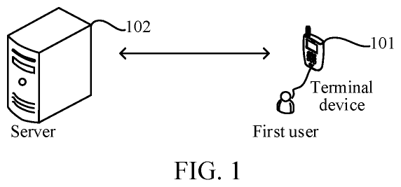

An embodiment of the present disclosure provides a multimedia processing system, with reference to FIG. 1 which is a schematic structural diagram of a multimedia processing system in an embodiment of the present disclosure. The multimedia processing system shown in FIG. 1 may include a terminal device 101 and a server 102.

The terminal device 101 may include, but is not limited to a smartphone, a tablet computer, a notebook computer, a desktop computer, a smart speaker, a smart watch, a car-mounted terminal, and a smart wearable device, and is generally equipped with a display device which may be a display, a display screen, a touch screens, etc., and the touch screen may be a touch control screen, a touch control panel, etc. Various applications (APPs), such as a social application, a browser application, and a conference application, may run on the terminal device 101. In an implementation of the embodiments of the present disclosure, a social application runs in the terminal device 101, the social application supports the access of a mini application which may include, but is not limited to a food service mini application, a network conversation mini application, an e-commerce shopping mini application, and an electronic invoicing mini application. The category of the mini application is not limited in the present disclosure.

The server 102 may be an independent physical server, or a server cluster or distributed system composed of a plurality of physical servers, or a cloud server providing basic cloud computation service such as cloud service, a cloud database, cloud computation, a cloud function, cloud storage, network service, cloud communication, middleware service, domain name service, security service, a content delivery network (CDN), and big data and an artificial intelligence platform. In an implementation of the embodiments of the present disclosure, a social application runs in the terminal device 101, and the server 102 may be a server corresponding to the social application and providing service support for the social application, for example, it may provide service support for instant messaging service provided by the social application, may provide service support for news sharing service provided by the social application, and may provide service support for online state sharing service provided by the social application. The terminal device 101 may be in direct or indirect communication connection with the server 102 by a wired or wireless communication way, which is not limited herein in the present disclosure.

The multimedia processing solution provided in the embodiments of the present disclosure may be implemented based on a multimedia processing system shown in FIG. 1, and a multimedia processing process involved to the multimedia processing system is to be introduced as follows:

the terminal device 101 displays a multimedia in a first form in a social media page, wherein the first form described herein may refer to a form in which the multimedia is not recognized and searched, such as a picture which has been sent, but has not been recognized and searched in a chat page. The terminal device 101 displays the multimedia in a second form in response to the multimedia in the first form being triggered, wherein the second form indicates that associated pages of the multimedia have been searched. The multimedia in the first form being triggered, which is described herein, means that the multimedia requires to further search relevant information, then, the terminal device 101 may acquire the associated pages of the multimedia, and display the multimedia in the second form to remind a user to view the searched associated pages. The terminal device 101 displays the associated pages in response to that the multimedia in the second form is triggered, so that the user can acquire more relevant information of the multimedia from the associated pages.

The social media page refers to any service page in the social application. The multimedia may be any multimedia displayed in the social media page, and the multimedia may be received by the terminal device 101 and displayed in the social media page, for example, the multimedia may be an image received by a first user by virtue of the terminal device 101 and sent by other users (such as a second user), that is, the image sent by the second user is displayed in the social media page in response to that the image is displayed on the social media page after being received by the terminal device 101 of the first user, wherein the first user is any user using service provided by the social application, and for facilitating description, the first user is to be described in the subsequent embodiments of the present disclosure. The first form of the multimedia indicates that the multimedia is in an unrecognized state, that is, to prompt that the associated pages of the multimedia have not been searched for the multimedia. The second form of the multimedia indicates that the multimedia is in a recognized state, that is, to prompt that the associated pages of the multimedia have been searched for the multimedia, and the associated pages of the multimedia have been searched. Page contents of the associated pages of the multimedia are matched with a multimedia content of the multimedia, that is, the associated pages of the multimedia may refer to pages of which page contents are matched with the multimedia content of the multimedia. For example, in response to that the multimedia is an image, and an image content of the image is a cake, the associated pages of the multimedia may be sale detail pages of a cake, making detail pages of a cake, etc. The associated pages of the multimedia may be a mini application page in the social application, service pages in other applications than the social application, a webpage, etc.

The multimedia in the second form may carry access link information of the associated pages of the multimedia, the access link information includes access paths of the associated pages of the multimedia, and the terminal device 101 may skip to the associated page based on the access link information and perform displaying in response to that the multimedia in the second form is triggered. The access link information carried in the multimedia in the second form may be acquired from the server 102 by the terminal device 101, that is, at any time after the terminal device 101 receives the multimedia, the terminal device 101 calls associated page search service provided by the server 102 to acquire the access link information, returned by the server 102, of the associated pages of the multimedia. Exemplarily, any time after the terminal device 101 receives the multimedia may be the time before the terminal device 101 displays the first form of the multimedia in the social media page after receiving the multimedia; or the time when the terminal device 101 displays the first form of the multimedia in the social media page after receiving the multimedia; or the time after the terminal device 101 displays the first form of the multimedia in the social media page after receiving the multimedia; or the time when it is detected by the terminal device 101 that the multimedia in the first form is triggered, etc. The terminal device 101 calls the associated page search service provided by the server 102 to acquire the access link information, returned by the server 102, of the associated pages of the multimedia, which is specifically: the terminal device 101 sends an associated page search request for searching the associated pages of the multimedia to the server 102, wherein the associated page search request carries the multimedia; and after receiving the associated page search request, the server 102 searches the access link information of the associated pages of the multimedia for the multimedia, and returns the access link information to the terminal device 101 after searching the access link information of the associated pages.

In an embodiment, the access link information carried in the multimedia in the second form may be searched by the terminal device 101, that is, the terminal device 101 may search the access link information of the associated pages of the multimedia for the multimedia at any time after the multimedia is received.

In an embodiment, the social media page may be any service page in the social application, the multimedia may be any multimedia displayed in the social media page, that is, for the multimedia included in any service page of the social application and displayed in the first form, the terminal device 101 may determine the associated pages of the multimedia based on search for the multimedia, and then display the associated pages of the multimedia. Specifically, for the multimedia included in any service page of the social application and displayed in the first form, the terminal device 101 may determine the associated pages of the multimedia based on search for the multimedia, display the second form, used to prompt that the associated pages of the multimedia have been searched, of the multimedia in response to the multimedia in the first form being triggered, and display the associated pages in response to that the multimedia in the second form is triggered.

The first form of the multimedia indicates that the multimedia is in an unrecognized state; the second form of the multimedia indicates that the multimedia is in a recognized state and the associated pages of the multimedia have been searched. In a possible implementation, the first form and the second form in response to that the multimedia is displayed may be designed to be different according to different requirements, that is, for multimedia in different social media pages, the multimedia in the different social media pages may be displayed as different interface performances when being displayed in the first form and may be displayed as different interface performances when being displayed in the second form. It is easy to understand that all interface performances capable of implementing the multimedia processing method provided in the embodiment of the present disclosure fall within the protection scope of the embodiments of the present disclosure.

In the embodiments of the present disclosure, a multimedia in a first form is displayed in a social media page, wherein the first form indicates that the multimedia is in an unrecognized state. The multimedia is displayed in a second form in response to the multimedia in the first form being triggered, wherein the second form indicates that associated pages of the multimedia have been searched. The multimedia in the first form being triggered, which is described herein, means that the multimedia requires to further search relevant information, then, the multimedia in the first form can be recognized, associated pages can be searched based on a recognition result, and the multimedia is displayed in the second form to remind a user to view the searched associated pages. The associated pages are displayed in response to that the multimedia in the second form is triggered, so that the user can acquire more relevant information of the multimedia from the associated pages, and the efficiency and convenience of information acquisition in social scenarios can be effectively improved.

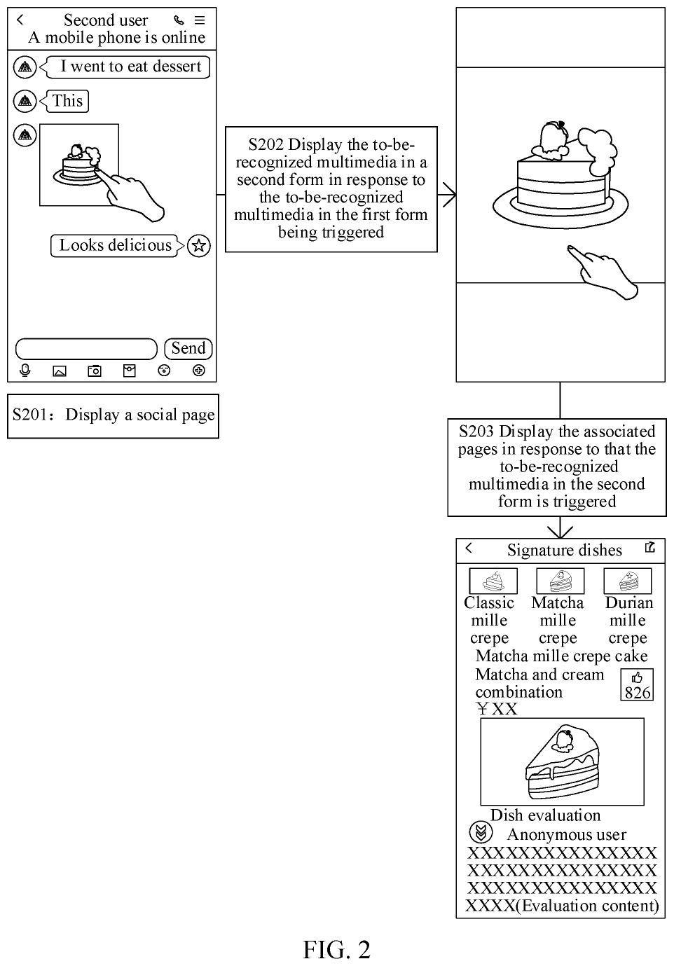

The multimedia processing method provided in the embodiment of the present disclosure is to be introduced in detail as follows. The multimedia processing method may be performed by a multimedia processing device which may be the terminal device in the multimedia processing system shown in FIG. 1, and the terminal device may independently complete corresponding processes of the multimedia processing method; of course, the terminal device may also complete the corresponding processes of the multimedia processing method under the assistance of the server shown in FIG. 1. With reference to FIG. 2 which is a schematic flowchart of a multimedia processing method exemplarily in an embodiment of the present disclosure, the multimedia processing method may include the following steps:

Step S201: Display a social media page.

The social media page may be any service page in a social application and may include a multimedia, and the multimedia is displayed in a first form. The multimedia may be any multimedia displayed in the social media page and may be received by the terminal device and displayed in the social media page. The first form indicates that the multimedia is in an unrecognized state, that is, to prompt that associated pages of the multimedia have not been searched for the multimedia. For facilitating description, the subsequent embodiments of the present disclosure are to be described with an example in which the social media page is a social media page corresponding to a first user using service provided by the social application, that is, the social media page is a social media page displayed in the terminal device of the first user.

For example, the social media page may be a chat page in the social application in a social scenario where social session is performed. In response to that the chat page is a chat page corresponding to the first user using the service provided by the social application, the chat page may be a chat page for session between the first user and any social friend of the first user, or a chat page for session of the first user in any user group where the first user is located, or a chat page for temporary session between the first user and a strange user using the social application, etc. The chat page may include one or more chat messages, and any one of the one or more chat messages may be generated based on a multimedia sent by the first user or a session user in session with the first user. For any chat message included in the chat page, a multimedia included therein is the multimedia in the first form, that is, the first form of the multimedia may be an interface performance of the multimedia displayed based on the chat message. With reference to FIG. 3 which is a schematic diagram of a chat page in an embodiment of the present disclosure, the chat page includes four chat messages generated during session between the first user and the second user; in response to that the first user is to trigger the chat message shown by numeral 301 in the four chat messages, and the chat message includes an image sent by the second user, the multimedia in the first form is the image displayed based on the chat message shown by numeral 301.

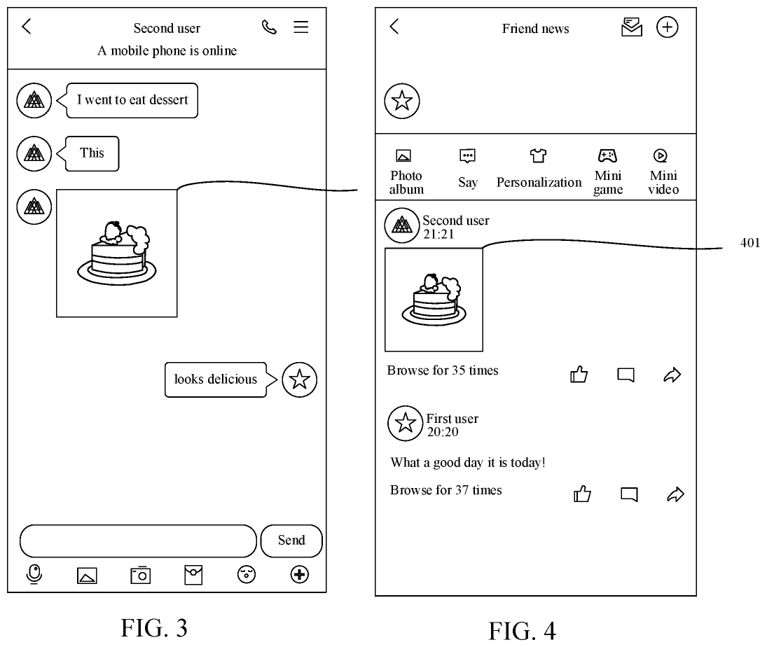

For another example, the social media page may be a friend news page in the social application in a social scenario where news sharing is performed. In response to that the news sharing page is a friend news page corresponding to the first user using the service provided by the social application, the friend news page may include one or more news messages, and any one of the one or more news messages may be generated based on a multimedia published by the first user or a social friend of the first user, for example, it may be news information generated based on a published text and only including the text, or news information generated based on a published image and only including the image, or news information generated based on the published text and image and including the text and the image, etc., that is, one piece of news information may at least include one of various media such as a text, an image, an audio, and a video. The multimedia included in any news information included in the friend news page is the multimedia in the first form, that is, the first form of the multimedia may be an interface performance of the multimedia displayed based on the news message. With reference to FIG. 4 which is a schematic diagram of a friend news page in an embodiment of the present disclosure, the friend news page includes two news messages published the first user and the second user; in response to that the first user is to trigger the news message shown by numeral 401 in the two news messages, and the news message includes an image published by the second user, the multimedia in the first form is the image displayed based on the news message shown by numeral 401.

For further example, the social media page may be a state query page of a social friend in the social application in a social scenario where online state sharing is performed. The state query page may be a state query page, triggered by the first user, of the first user or a state query page of any social friend of the first user, that is, the social friend described herein may refer to the first user or any social friend of the first user. The state query page may include identity information of the social friend, and the identity information of the social friend may include a nickname, a logo, i.e., an identity document (ID), a head portrait, etc. of the social friend. The state query page may further include a state content published by the social friend, and the state content may be used to represent an online state of the social friend, for example, it may include a state label, a state description text and a state description image which are set by the social friend, and the multimedia in the first form in the state content is the state description image included in the state content.

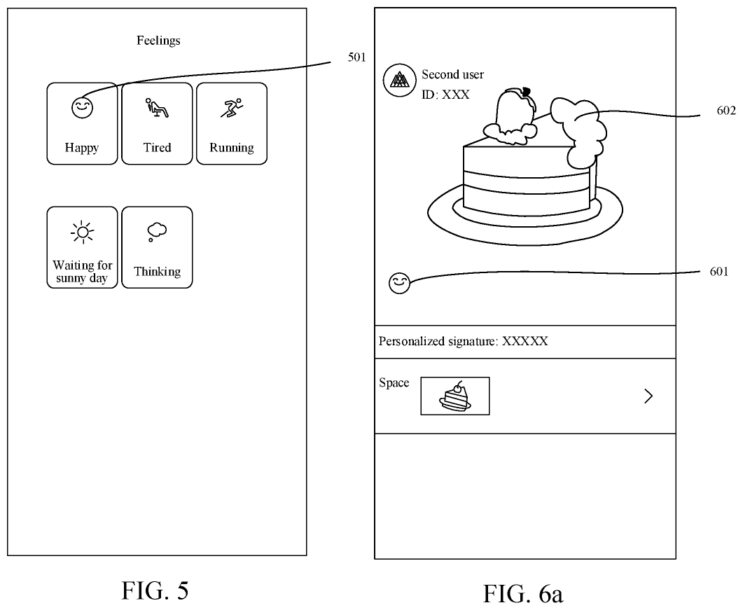

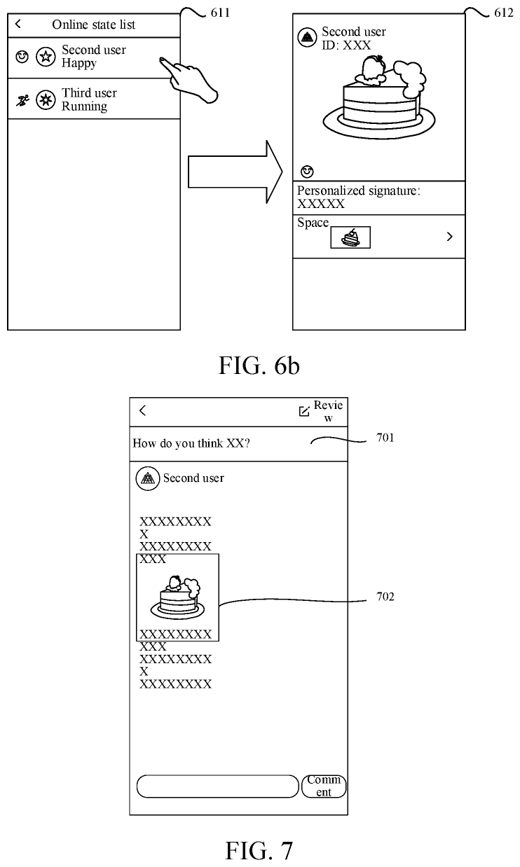

The state label set by the social friend is one of a plurality of state labels which may be an icon designed based on a specific business requirement and used to express an online state of a user, one state label corresponds to one state description text for describing a specific meaning of the state label, the state description text set by the social friend is a state description text corresponding to the state label set by the social friend, and the state description image set by the social friend may be any image set by the social friend according to his/her preferences. With reference to FIG. 5 which is a schematic diagram of a state label and a state description text in an embodiment of the present disclosure, wherein one state label may be shown as numeral 501, the state label is used to describe feelings, and the state description text corresponding to the state label is “happy”. The state label included in FIG. 5 is an exemplarily given state label and may be set according to a specific business requirement, for example, it may further include an online state, an offline state, music, watching TV and running. With reference to FIG. 6a which is a schematic diagram of a state query page of a target social friend in an embodiment of the present disclosure, the social friend is the second user, a state label included in a state content set by the social friend may be shown as numeral 601, the state description text of the state label shown as numeral 601 is “happy”, the state description image included in the state content set by the social friend may be shown as numeral 602, that is, the multimedia in the first form is the state description image displayed in the state query page and shown as numeral 602. Further, the state query page of the social friend may be triggered based on a state list, the state list may include one or more state characterization items, and different state characterization items in the one or more state characterization items are used to trigger the display of the state query pages of different social friends. One of the one or more state characterization items may include identity information of a social friend whose online state is set and a state content set by the social friend. With reference to FIG. 6b which is a schematic diagram of an operation of triggering the display of the state query page of the target friend in an embodiment of the present disclosure, the state list may be shown as numeral 611 in response to that a second user and a third user in social friends of the first user set online states, and the terminal device may display the state query page, shown as numeral 612, of the second user in response to that the first user triggers the state characterization item corresponding to the second user in the state list.

For yet further example, the social media page may be a topic page in the social application in a social scenario where topic discussion is performed. In response to that the topic page is a topic page corresponding to the first user using the service provided by the social application, the topic page may be a page for describing any topic triggered by the first user, any topic triggered by the first user may be published by any user, such as the first user or any social friend of the first user, a user having rights to browse the topic in the topic page may view the topic page, and a user having rights to comment the topic may comment the topic, so that communication between the users is achieved. The topic page may include a topic content for describing the topic, for example, it may include a topic title, a topic description content, a topic reply, etc. One topic reply may refer to a content which is published for the topic by a user having rights to comment the topic and may be used to represent the user's view for the topic; and the topic description content and the topic reply may include multimedia such as a text, an audio, an image, and a video. The multimedia performing display based on the topic page is the multimedia in the first form, the topic page includes the multimedia in the first form, and the multimedia in the first form may be any multimedia included in the topic page, for example, it may be an image, a video, etc. With reference to FIG. 7 which is a schematic diagram of a topic page in an embodiment of the present disclosure, the topic title in the topic page may be shown as numeral 701, for example, the first user is to trigger an image shown as numeral 702 in the topic page, then, the multimedia in the first form in the topic page is the image shown as numeral 702.

Step S202: Display the multimedia in a second form in response to the multimedia in the first form being triggered.

The second form indicates that associated pages of the multimedia have been searched, and indicates that the multimedia is in a recognized state, that is, to prompt that the associated pages of the multimedia have been searched for the multimedia, and the associated pages of the multimedia have been searched. Page contents of the associated pages of the multimedia are matched with a multimedia content of the multimedia.

In an embodiment, the multimedia in the second form may be displayed based on a multimedia browsing window, and the multimedia browsing window may be a page window different from the social media page or a popup window covering the social media page, etc. In the embodiments of the present disclosure, a specific display way of the multimedia browsing window is not limited, and interface performances of the multimedia browsing window capable of displaying the second form of the multimedia fall within the protection scope of the embodiments of the present disclosure. In a possible implementation, the terminal device may display the multimedia in the second form in response to the multimedia in the first form being triggered in a way of outputting the multimedia browsing window in response to the multimedia in the first form being triggered; and displaying the multimedia in the second form in the multimedia browsing window. The trigger operation may include, but is not limited to any one shown as follows: a clicking operation, a pressing gesture operation, and a suspending gesture operation.

In an embodiment, the multimedia in the second form may include an interaction label indicating a presence of a social friend associated with the multimedia. The interaction label is displayed in the multimedia in the second form in any one of the following ways that: the interaction label is displayed on any position in the multimedia in the second form; or, the interaction label is displayed in a suspended way in the multimedia in the second form; or, the interaction label is displayed around the multimedia in the second form; or, the interaction label defaults to be hidden and is only displayed in response to that a staying signal exists in the multimedia in the second form; the interaction label includes any one shown as follows: a prompt text, a prompt animation, and identity information of the social friend; and the identity information including es any one shown as follows: a nickname, a logo, and a head portrait.

The interaction label indicates the presence of a social friend associated with the multimedia, and the social friend associated therewith may be a social friend whose behaviors are associated with the multimedia content in the multimedia, for example, in response to that the multimedia is an image including a cake, the social friend associated with the multimedia may be a user who has eaten the cake in the multimedia; and in response to that the multimedia is an image including a scenic spot, the social friend associated with the multimedia may be a user who has been to the scenic spot in the multimedia. The interaction label includes a label content which may be a content used to prompt the presence of the social friend associated with the multimedia and may be the above-mentioned prompt text, prompt animation or identity information of the social friend. The prompt text may be designed according to a specific business requirement. For example, it is possible that “a friend is eating” or “a friend XX is eating” represents the presence of a social friend who has eaten the multimedia content included in the multimedia; “a friend is playing” or “a friend XX is playing” represents the presence of a social friend who has played the multimedia content included in the multimedia, such as a toy included in the multimedia; “a friend has been a place” or “a friend XX has been a place” represents the presence of a social friend who has been a place included in the multimedia; “a friend has been a place” or “a friend XX has been a place” represents the presence of a social friend who has been a place included in the multimedia; and “a friend is buying” or “a friend XX is buying” represents the presence of a social friend who has bought the multimedia content included in the multimedia, such as sunflowers included in the multimedia.

The prompt animation may also be an animation designed according to a specific business requirement, for example, the prompt animation may be a constantly-lighting icon (such as a constantly-lighting circular icon, square icon, etc.), an icon flickering at a certain frequency, etc. In response to that the interaction label defaults to be hidden and is only displayed in response to that a staying signal exists in the multimedia in the second form, the staying signal may be a staying signal, such as long-press and double-click, detected by the terminal device, and the interaction label may be displayed in the multimedia in the second form based on the above-mentioned ways in response to that the staying signal exists in the multimedia in the second form, for example, the interaction label is displayed on any position in the multimedia in the second form; or, the interaction label is displayed in a suspended way in the multimedia in the second form; or, the interaction label is displayed around the multimedia in the second form.

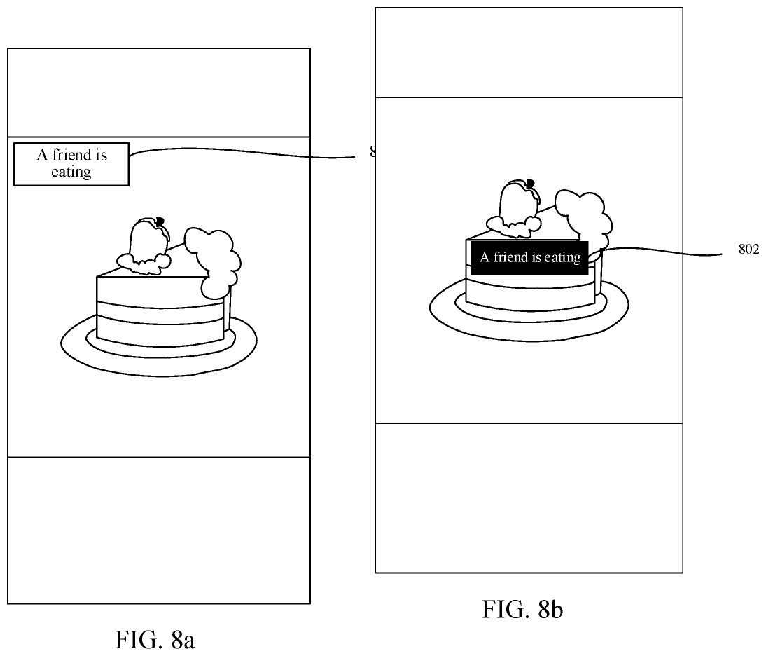

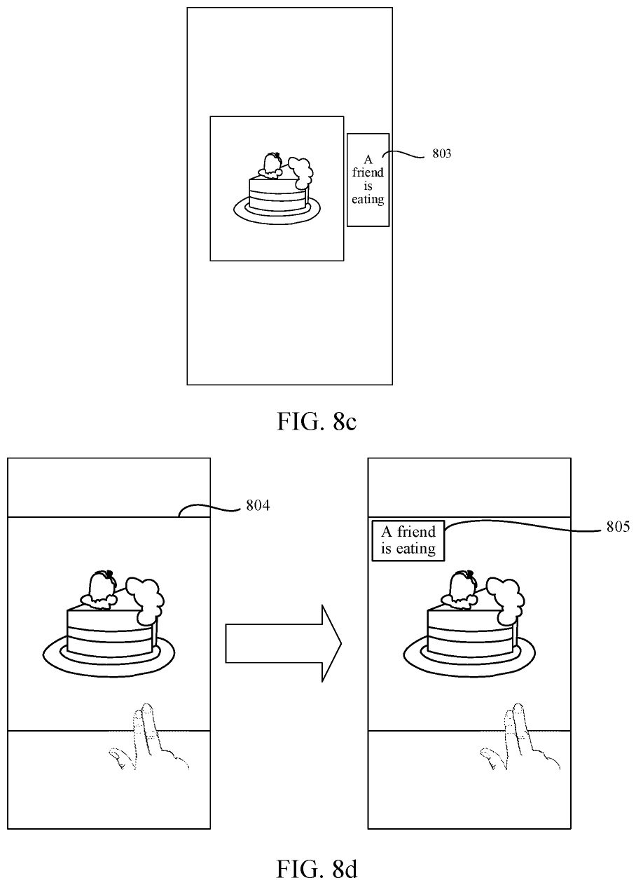

Based on an example in which the interaction label includes the prompt text, it is assumed that the multimedia content of the multimedia in the second form is a cake, and the interaction label may be “a friend is eating”. With reference to FIG. 8a which is a schematic diagram of a multimedia including an interaction label and being in a second form in an embodiment of the present disclosure, the interaction label is displayed on the upper left corner of the multimedia in the second form, which is specifically shown as numeral 801. With reference to FIG. 8b which is a schematic diagram of another multimedia including an interaction label and being in a second form in an embodiment of the present disclosure, the interaction label is displayed in a suspended way in the multimedia in the second form, which is specifically shown as numeral 802. With reference to FIG. 8c which is a schematic diagram of further multimedia including an interaction label and being in a second form in an embodiment of the present disclosure, the interaction label is displayed around the multimedia in the second form and is specifically displayed on the right of the multimedia in the second form, which is shown as numeral 803. With reference to FIG. 8d which is a schematic diagram of yet further multimedia including an interaction label and being in a second form in an embodiment of the present disclosure, the interaction label defaults to be hidden, at the moment, the multimedia in the second form may be shown as numeral 804, and the interaction label is only displayed in response to that a staying signal exists in the multimedia in the second form, for example, the interaction label is displayed on the upper left corner of the multimedia in the second form in response to that a staying signal, i.e., long-press, exists in the multimedia in the second form, which may be specifically shown as numeral 805.

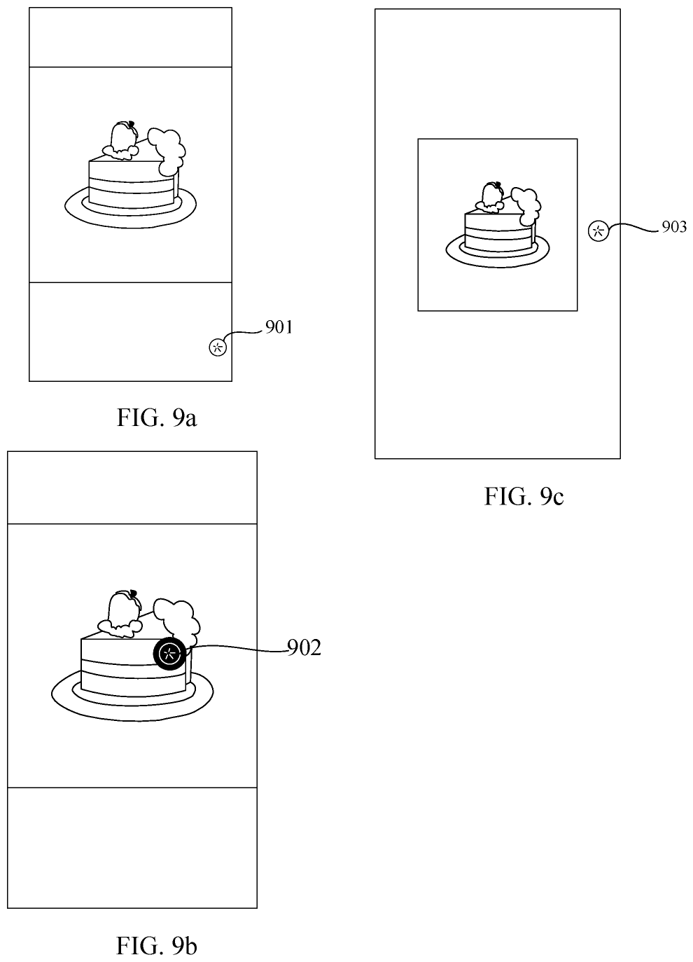

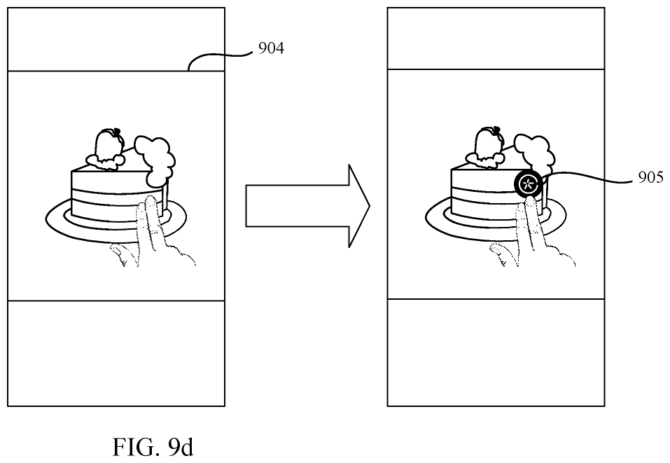

In an embodiment, the multimedia in the second form includes associated page trigger controls, wherein the associated page trigger controls are used to trigger the display of the associated pages of the multimedia, and interface performances and display positions of the associated page trigger controls may be designed according to specific requirements. The associated page trigger controls may be displayed in the multimedia in the second form in any one of the following ways that: the associated page trigger controls are displayed on any positions in the multimedia in the second form; or, the associated page trigger controls are displayed in a suspended way in the multimedia in the second form; or, the associated page trigger controls are displayed around the multimedia in the second form; or, the associated page trigger controls default to be hidden and are only displayed in response to that a staying signal exists in the multimedia in the second form. In response to that the associated page trigger controls default to be hidden and are only displayed in response to that a staying signal exists in the multimedia in the second form, the staying signal may be a staying signal, such as long-press and double-click, detected by the terminal device, and the associated page trigger controls may be displayed in the multimedia in the second form based on the above-mentioned ways in response to that the staying signal exists in the multimedia in the second form, for example, the associated page trigger controls are displayed on any positions in the multimedia in the second form; or, the associated page trigger controls are displayed in a suspended way in the multimedia in the second form; or, the associated page trigger controls are displayed around the multimedia in the second form. With reference to FIG. 9a which is a schematic diagram of a multimedia including associated page trigger controls and being in a second form in an embodiment of the present disclosure, the associated page trigger controls are displayed on the lower right corner of the multimedia in the second form, which is specifically shown as numeral 901. With reference to FIG. 9b which is a schematic diagram of another multimedia including associated page trigger controls and being in a second form in an embodiment of the present disclosure, the associated page trigger controls are displayed in a suspended way in the multimedia in the second form, which is specifically shown as numeral 902. With reference to FIG. 9c which is a schematic diagram of further multimedia including associated page trigger controls and being in a second form in an embodiment of the present disclosure, the associated page trigger controls are displayed around the multimedia in the second form and are specifically displayed on the right of the multimedia in the second form, which is specifically shown as numeral 903. With reference to FIG. 9d which is a schematic diagram of yet further multimedia including associated page trigger controls and being in a second form in an embodiment of the present disclosure, the associated page trigger controls default to be hidden, at the moment, the multimedia in the second form may be shown as numeral 904, and the associated page trigger controls are only displayed in response to that the staying signal, such as long-press, exists in the multimedia in the second form, for example, the associated page trigger controls may be shown as numeral 905 in response to that the staying signal exists in the multimedia in the second form.

In an embodiment, the multimedia may have a plurality of associated pages, that is, a plurality of pages of which the page contents are matched with the multimedia content of the multimedia are determined based on search for the multimedia. In this case, the multimedia in the second form may include a plurality of associated page trigger controls, each of the associated page trigger controls is used to trigger the display of one of the associated pages of the multimedia, and interface performances and display positions of the plurality of associated page trigger controls may be designed according to specific requirements. The plurality of associated page trigger controls may be displayed in the multimedia in the second form in any one of the following ways that: the associated page trigger controls are displayed in a randomly distributed way in the multimedia in the second form; the associated page trigger controls are displayed in an orderly arranged way in the multimedia in the second form; the associated page trigger controls are displayed around the multimedia in the second form.

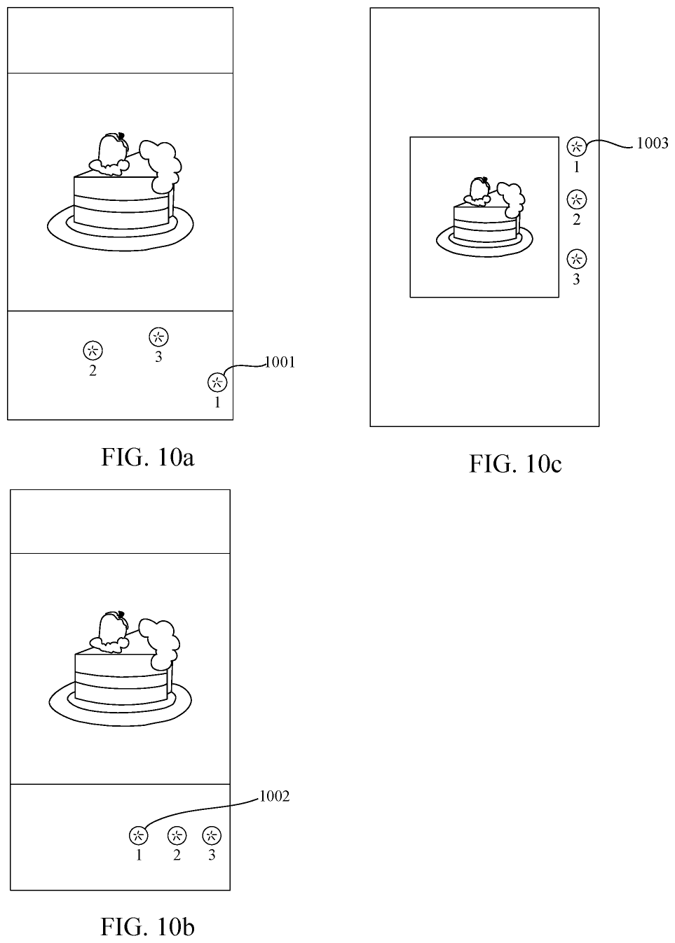

In order to distinguish the different associated pages, corresponding to the different associated page trigger controls, of the multimedia, the associated page trigger controls used to trigger the display of the different associated pages may have different interface performances, and the interface performance of each of the associated page trigger controls may be designed according to specific requirements. It is assumed that the multimedia has three associated pages, at the moment, the multimedia in the second form includes three associated page trigger controls. With reference to FIG. 10a which is a schematic diagram of a multimedia including a plurality of associated page trigger controls and being in a second form in an embodiment of the present disclosure, at the moment, the plurality of associated page trigger controls are displayed in a randomly distributed way in the multimedia in the second form, and one of the plurality of associated page trigger controls may be shown as numeral 1001. With reference to FIG. 10b which is a schematic diagram of another multimedia including a plurality of associated page trigger controls and being in a second form in an embodiment of the present disclosure, at the moment, the associated page trigger controls are displayed in an orderly arranged way in the multimedia in the second form and are specifically displayed in an orderly arranged way below the multimedia in the second form, and one of the plurality of associated page trigger controls may be shown as numeral 1002. With reference to FIG. 10c which is a schematic diagram of further multimedia including a plurality of associated page trigger controls and being in a second form in an embodiment of the present disclosure, the associated page trigger controls are displayed around the multimedia in the second form and may be specifically displayed on the right of the multimedia in the second form, and one of the plurality of associated page trigger controls may be shown as numeral 1003.

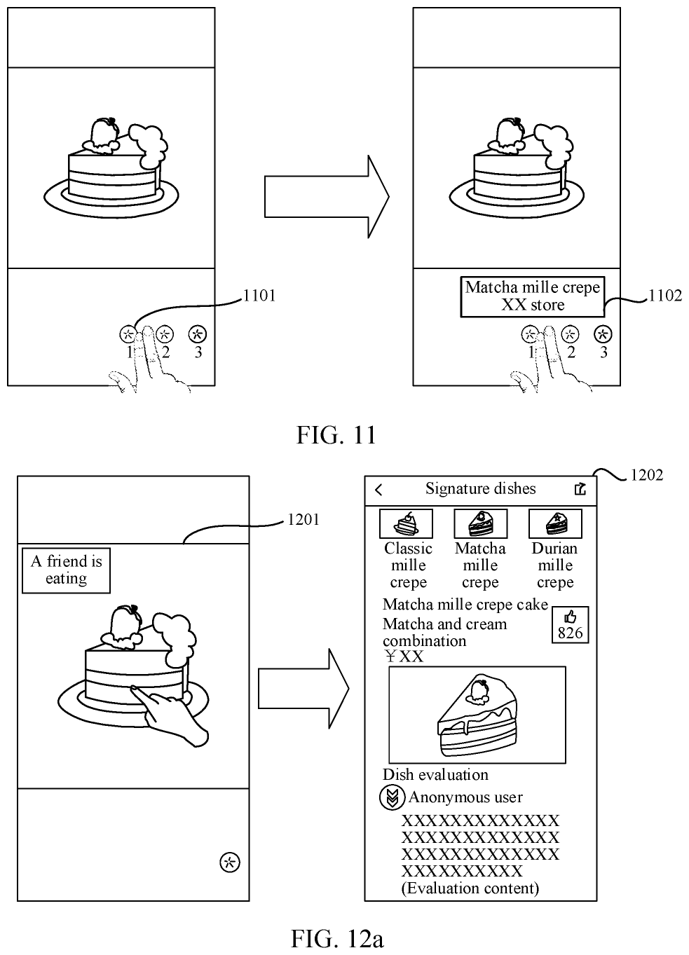

In order to distinguish the different associated pages, corresponding to the different associated page trigger controls, of the multimedia, page description information of an associated page pointed by any one of the associated page trigger controls may be displayed in response to that the terminal device detects a staying signal for any one of the plurality of associated page trigger controls, wherein the page description information is used to describe the associated page. The display of the page description information of the associated page pointed by the associated page trigger control is canceled in response to that it is detected by the terminal device that the staying signal for the associated page trigger control disappears. The staying signal may be a staying signal, such as long-press and double-click, detected by the terminal device. For example, it is assumed that the multimedia has three associated pages, at the moment, the multimedia in the second form includes three associated page trigger controls which are respectively an associated page trigger control 1 pointing to an associated page 1, an associated page trigger control 2 pointing to an associated page 2, and an associated page trigger control 3 pointing to an associated page 3. As shown in FIG. 11 which is a schematic diagram of an operation of displaying page description information of associated pages based on the associated page trigger controls in an embodiment of the present disclosure, in response to that the first user long presses on the associated page trigger control 1 shown as numeral 1101, the terminal device detects a staying signal for the associated page trigger control 1, and displays page description information of the associated page 1 pointed by the associated page trigger control 1, wherein the page description information may be shown as numeral 1102 and is specifically displayed as “Matcha mille crepe XX store”.

Step S203: Display the associated page in response to that the multimedia in the second form is triggered.

Page contents of one or more associated pages of the multimedia are matched with a multimedia content of the multimedia, that is, the one or more associated pages of the multimedia may be one or more pages of which page contents are matched with the multimedia content of the multimedia. For example, in response to that the multimedia is an image, and an image content of the image is a cake, the associated pages of the multimedia may be sale detail pages of a cake, making detail pages of a cake, etc.

In an embodiment, the associated pages of the multimedia may be a mini application page in the social application, service pages in other applications than the social application, a webpage, etc. In response to that the associated pages of the multimedia are the mini application pages in the social application and the multimedia in the second form is triggered, the terminal device may display the associated pages based on the social application, that is, the mini application pages may be displayed based on the social application. In response to that the associated pages of the multimedia are the service pages in other applications than the social application and the multimedia in the second form is triggered, the terminal device may display the associated pages based on the social application, that is, the service pages in other applications may be displayed based on the social application; or the associated pages may be displayed based on other applications, that is, the service pages in other applications may be displayed based on other applications. In a feasible implementation, in response to that the associated pages of the multimedia are the service pages in other applications than the social application and the multimedia in the second form is triggered, the terminal device may display the associated pages based on the social application, skip controls are displayed in the associated pages, and the skip controls are used to skip to other applications to display the associated pages; in response to that the skip controls are triggered, the terminal device detects whether other applications are installed in the terminal device, and in response to that it is detected that other applications are installed in the terminal device, other applications are started, and the associated pages are displayed based on other applications; in response to that it is not detected that other applications are not installed in the terminal device, the page skips to an application download page, other applications are downloaded based on a conformation operation for downloading other applications from the first user, and after the download is completed, other applications are started, and the associated pages are displayed based on other applications. In response to that the associated pages of the multimedia are the webpages and the multimedia in the second form is triggered, the terminal device may display the associated pages based on the social application, that is, the webpages may be displayed based on the social application; or the associated pages may be displayed based on a browser installed in the terminal device, that is, the webpages may be displayed based on the browser installed in the terminal device. In a feasible implementation, in response to that the associated pages of the multimedia are the webpages and the multimedia in the second form is triggered, the terminal device may display the associated pages based on the social application, skip controls are displayed in the associated pages, and the skip controls are used to skip to the browser to display the associated pages; in response to that the skip controls are triggered, the terminal device starts the browser and displays the associated pages based on the browser.

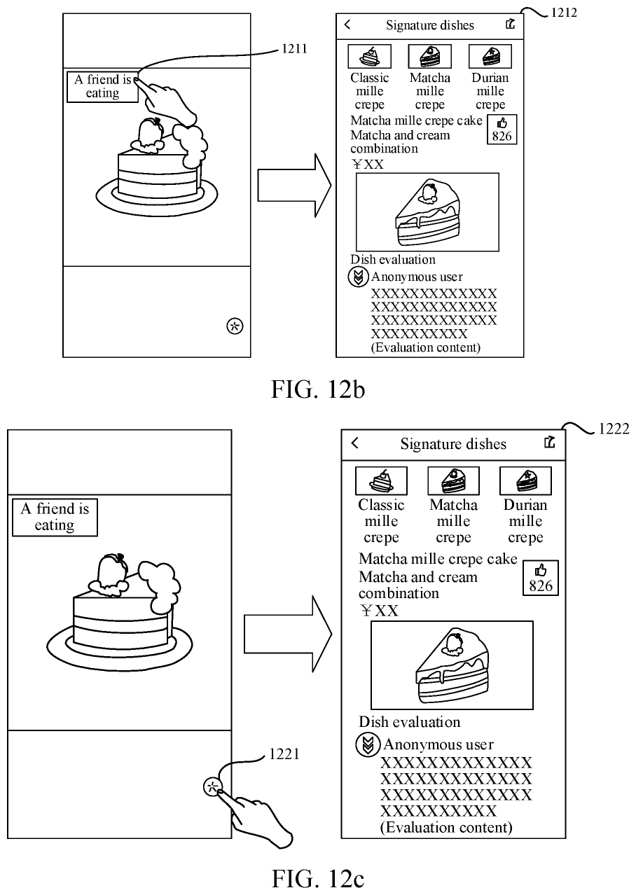

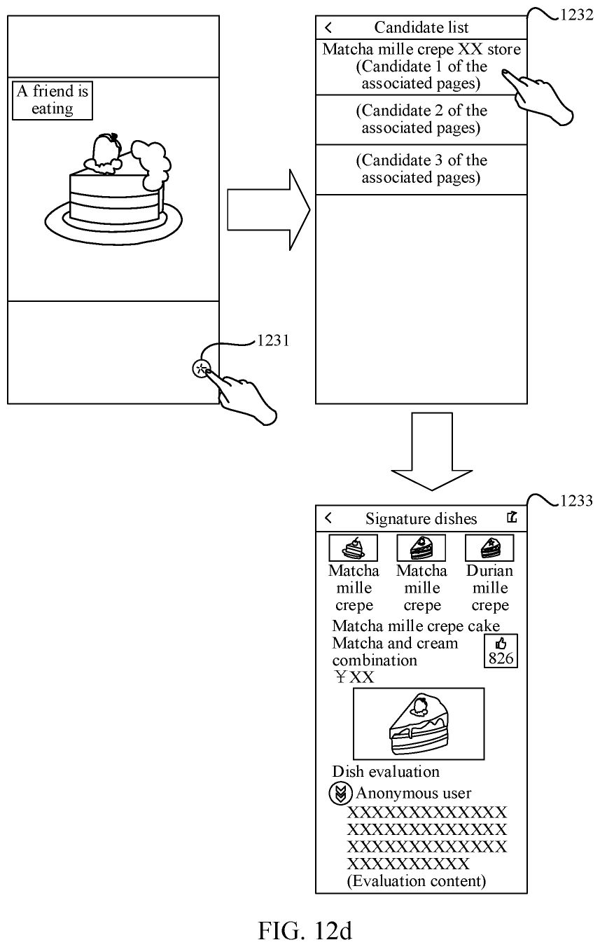

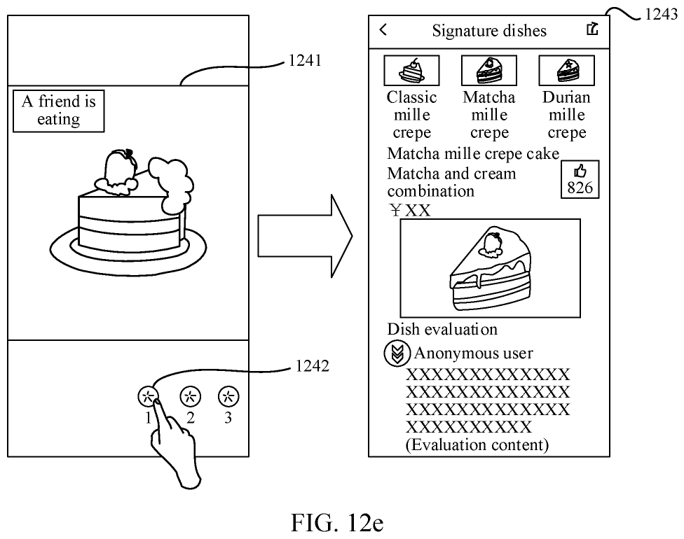

In an embodiment, in response to that the multimedia in the second form is triggered, the terminal device may display the associated pages in a way of displaying the associated pages in response to that a trigger operation is performed on the multimedia in the second form, wherein the trigger operation includes any one shown as follows: a clicking operation, a pressing gesture operation, and a suspending gesture operation. For example, it is assumed that the multimedia is an image of which the image content is a cake, and the associated pages of the multimedia are the mini application pages, with reference to FIG. 12a which is a schematic diagram of an operation of triggering the display of the associated pages of the multimedia in an embodiment of the present disclosure, wherein the multimedia in the second form is shown as numeral 1201, in response to that the first user performs the trigger operation on the multimedia in the second form, the associated pages of the multimedia shown as numeral 1202 may be displayed as sale detail pages, including contents such as a name, price, introduction, and comment, of a cake in the terminal device.

In an embodiment, in response to that the multimedia in the second form includes the interaction label and is triggered, the terminal device may display the associated pages in a way of displaying the associated pages in response to that a trigger operation is performed on the interaction label, wherein the trigger operation includes, but is not limited to any one shown as follows: a clicking operation, a pressing gesture operation, and a suspending gesture operation. For example, it is assumed that the multimedia is an image of which the image content is a cake, and the associated pages of the multimedia are the mini application pages, with reference to FIG. 12b which is a schematic diagram of an operation of triggering the display of the associated pages of the multimedia based on the interaction label in an embodiment of the present disclosure, wherein the interaction label included in the multimedia in the second form is shown as numeral 1211, in response to that the first user performs the trigger operation on the interaction label, the associated pages of the multimedia shown as numeral 1212 may be displayed as sale detail pages, including contents such as a name, price, introduction, and comment, of a cake in the terminal device.

In an embodiment, in response to that the multimedia in the second form includes the associated page trigger controls and is triggered, the terminal device may display the associated pages in a way of displaying the associated pages in response to that a trigger operation is performed on the associated page trigger controls. For example, it is assumed that the multimedia is an image of which the image content is a cake, and the associated pages of the multimedia are the mini application pages, with reference to FIG. 12c which is a schematic diagram of an operation of triggering the display of the associated pages of the multimedia based on the associated page trigger controls in an embodiment of the present disclosure, wherein an associated page trigger control included in the multimedia in the second form is shown as numeral 1221, in response to that the first user performs the trigger operation on the associated page trigger control, the associated pages of the multimedia shown as numeral 1222 may be displayed as sale detail pages, including contents such as a name, price, introduction, and comment, of a cake in the terminal device.

In response to that the multimedia has a plurality of associated pages and a trigger operation is performed on the associated page trigger controls, the terminal device may display the associated pages in a way of displaying a candidate list in response to that the trigger operation is performed on the associated page trigger controls, the candidate list including a plurality of candidates of the associated pages; different candidates of the associated pages in the plurality of candidates of the associated pages being used to trigger the display of different associated pages of the multimedia; and displaying an associated page indicated by a selected candidate of the associated pages in response to that any one of the candidates of the associated pages in the candidate list is selected. One candidate of the associated pages in the candidate list may include page description information of the associated page indicated by the one candidate of the associated pages, wherein the page description information is used to describe the associated page. For example, it is assumed that the multimedia has three associated pages, at the moment, the candidate list includes three candidates of the associated pages, which are respectively a candidate 1 of the associated pages, a candidate 2 of the associated pages, and a candidate 3 of the associated pages, and the three candidates of the associated pages respectively indicate an associated page 1, an associated page 2, and an associated page 3. As shown in FIG. 12d which is a schematic diagram of an operation of displaying the associated pages based on a candidate list in an embodiment of the present disclosure, wherein an associated page trigger control included in the multimedia in the second form is shown as numeral 1231, in response to that the first user performs the trigger operation on the associated page trigger control, the terminal device displays the candidate list shown as numeral 1232, and the candidate list includes the candidate 1 of the associated pages, a candidate 2 of the associated pages, and a candidate 3 of the associated pages. In response to that the first user selects the candidate 1 of the associated pages, with the associated page description information being “Matcha mille crepe XX store”, in the candidate list, the associated page 1 which is indicated by the selected candidate 1 of the associated pages and may be shown as numeral 1233 may be displayed in the terminal device.

In an embodiment, in response to that the multimedia has a plurality of associated pages, and the multimedia in the second form includes a plurality of associated page trigger controls and is triggered, the terminal device may display the associated pages in a way of displaying an associated page indicated by a triggered associated page trigger control in response to that any one of the plurality of associated page trigger controls is triggered. For example, it is assumed that the multimedia has three associated pages, at the moment, the multimedia in the second form includes three associated page trigger controls which are respectively an associated page trigger control 1 indicating an associated page 1, an associated page trigger control 2 indicating an associated page 2, and an associated page trigger control 3 indicating an associated page 3. As shown in FIG. 12e which is a schematic diagram of an operation of triggering the display of the associated pages based on the plurality of associated page trigger controls in an embodiment of the present disclosure, wherein the multimedia including the plurality of associated page trigger controls and being in the second form may be shown as numeral 1241, in response to that the first user performs a trigger operation on the associated page trigger control 1, with the associated page description information being “Matcha mille crepe XX store” shown as numeral 1242, in the plurality of associated page trigger controls, the associated page 1 which is indicated by the associated page trigger control 1 and may be shown as numeral 1243 may be displayed in the terminal device.

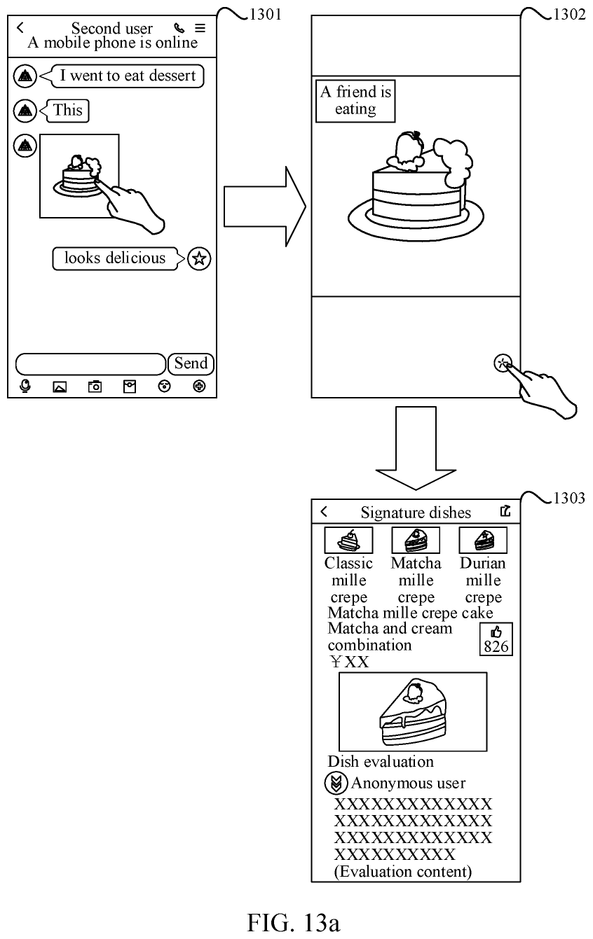

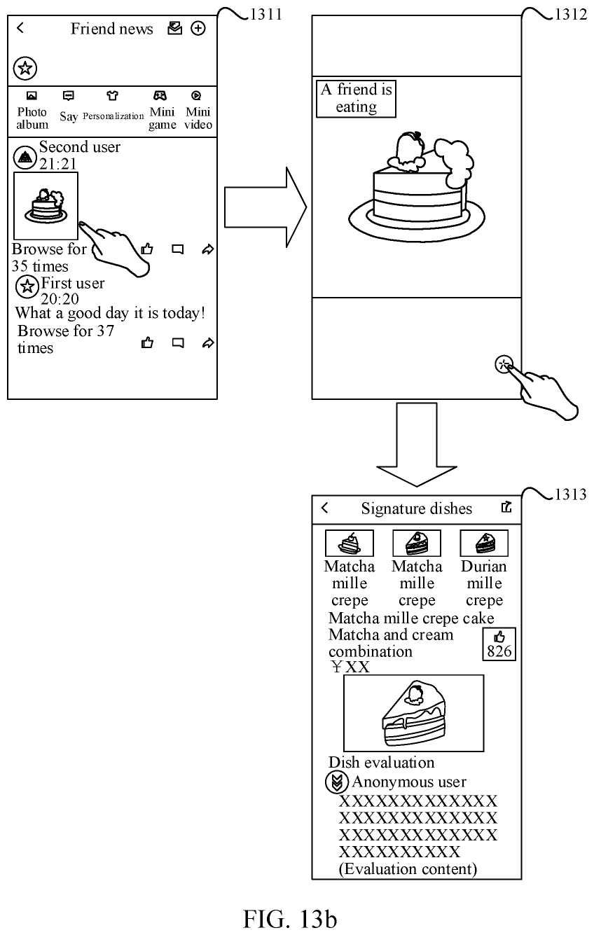

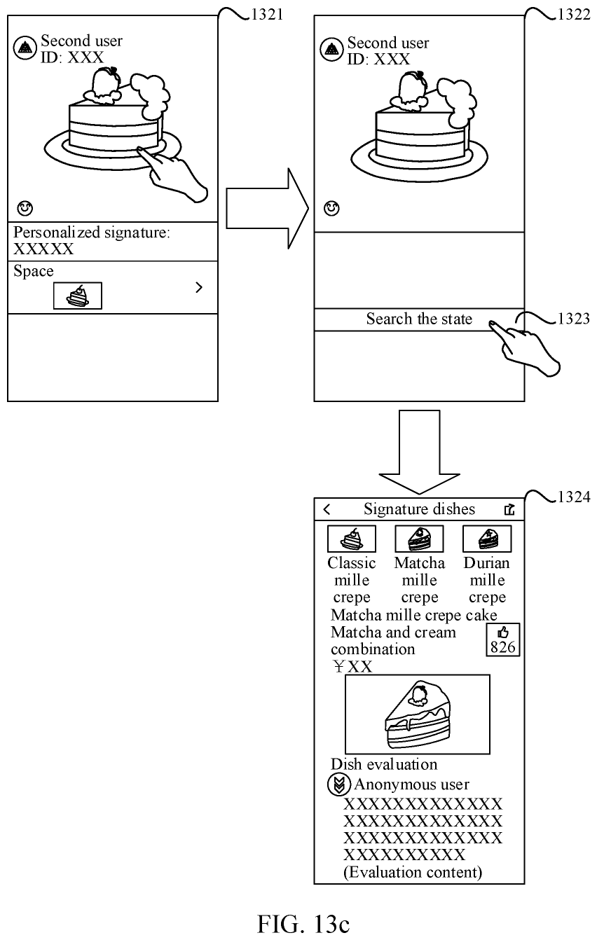

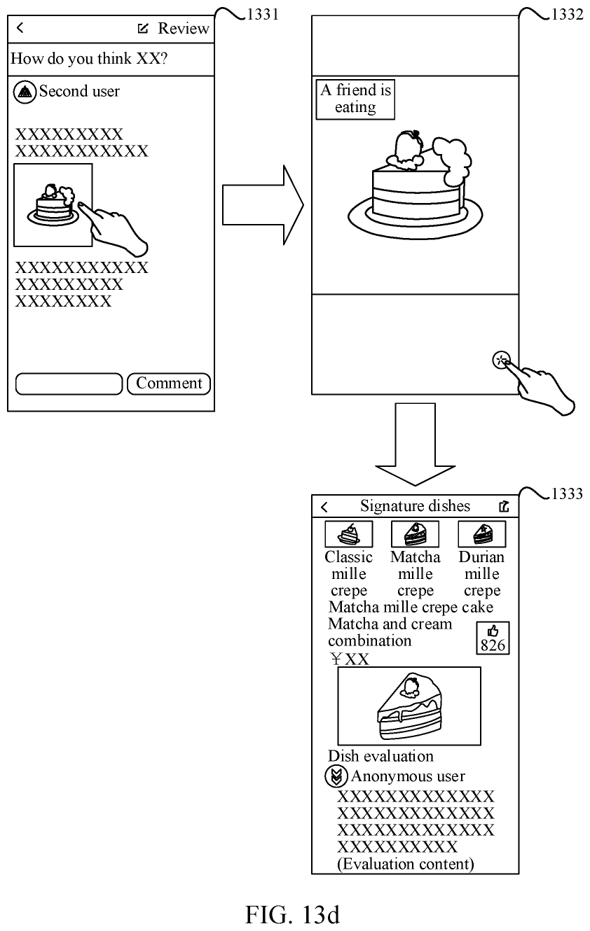

With reference to FIG. 13a which is a schematic diagram of an operation of triggering the display of the associated pages of the multimedia on a social media page in an embodiment of the present disclosure, it is assumed that the social scenario is a social scenario where social session is performed, and is specifically a social scenario for session between the first user and the second user, the social media page is the chat page in the social application, which may be shown as numeral 1301 and includes four chat messages. In response to that the first user triggers one of the chat messages, wherein the chat message includes an image which is sent by the second user and of which an image content is a cake, the terminal device may display the multimedia in the second form, that is, the second form, which may be shown as numeral 1302, of the image may be displayed, and the multimedia in the second form shown as numeral 1302 includes an interaction label and an associated page trigger control. In response to that the first user triggers the interaction label or the associated page trigger control, the terminal device may display associated pages of multimedia shown as numeral 1303, i.e., associated pages of the image, and the associated pages are sale detail pages, including contents such as a name, price, introduction, and comment, of a cake matched with the cake included in the image.

With reference to FIG. 13b which is a schematic diagram of another operation of triggering the display of the associated pages of the multimedia on a social media page in an embodiment of the present disclosure, it is assumed that the social scenario is a social scenario where news sharing is performed, the social media page is the friend news page in the social application, which may be shown as numeral 1311 and includes two news messages. In response to that the first user triggers one of the news messages, wherein the news message is published by the second user and includes an image which is published by the second user and of which an image content is a cake, the terminal device may display the multimedia in the second form, that is, the second form, which may be shown as numeral 1312, of the image may be displayed, and the multimedia in the second form shown as numeral 1312 includes an interaction label and an associated page trigger control. In response to that the first user triggers the interaction label or the associated page trigger control, the terminal device may display associated pages of multimedia shown as numeral 1313, i.e., associated pages of the image, and the associated pages are sale detail pages, including contents such as a name, price, introduction, and comment, of a cake matched with the cake included in the image.

With reference to FIG. 13c which is a schematic diagram of further operation of triggering the display of the associated pages of the multimedia in a social media page in an embodiment of the present disclosure, it is assumed that the social scenario is a social scenario where online state sharing is performed, the social media page is the state query page of the social friend in the social application, which may be shown as numeral 1321 and includes a state content published by the social friend, the state content includes a state description image set by the second user, and an image content of the state description image is a cake. In response to that the first user triggers the state description image, the terminal device may display the multimedia in the second form, that is, the second form, which may be shown as numeral 1322, of the state description image may be displayed, and the multimedia in the second form shown as numeral 1322 includes an associated page trigger control which is specifically shown as numeral 1323. In response to that the first user triggers the associated page trigger control, the terminal device may display associated pages of multimedia shown as numeral 1324, i.e., associated pages of the state description image, and the associated pages are sale detail pages, including contents such as a name, price, introduction, and comment, of a cake matched with the cake included in the state description image.

With reference to FIG. 13d which is a schematic diagram of yet further operation of triggering the display of the associated pages of the multimedia on a social media page in an embodiment of the present disclosure, it is assumed that the social scenario is a social scenario where topic discussion is performed, the social media page is the topic page in the social application, which may be shown as numeral 1331 and includes a topic content, and the topic content includes an image of which an image content is a cake. In response to that the first user triggers the image, the terminal device may display the multimedia in the second form, that is, the second form, which may be shown as numeral 1332, of the image may be displayed, and the multimedia in the second form shown as numeral 1332 includes an interaction label and an associated page trigger control. In response to that the first user triggers the interaction label or the associated page trigger control, the terminal device may display associated pages of multimedia shown as numeral 1333, i.e., associated pages of the image, and the associated pages are sale detail pages, including contents such as a name, price, introduction, and comment, of a cake matched with the cake included in the image.

In a possible implementation, the associated pages of the multimedia may be searched after a search function is enabled for the multimedia, that is, a user publishing the multimedia may decide whether to enable the search function for the multimedia. The user publishing the multimedia performs the same operation in response to that the search function is enabled for the multimedia, that is, the same operation is performed on the multimedia in response to that the multimedia is published by the first user or a social friend of the first user. In view of this, in the embodiments of the present disclosure, the process that the search function is enabled for the multimedia is described in response to that the multimedia is published by the first user. The terminal device outputs a search authorization prompt in response to that the multimedia to be published to the social media page is detected, the search authorization prompt indicating that the search function is enabled for the multimedia; and enables the search function for the multimedia in response to that confirmation information of the search authorization prompt is received. Further, the terminal device receives the multimedia and displays the social media page, the social media page includes the multimedia, and the multimedia is displayed in the first form, that is, the multimedia is displayed in the first form in the social media page in response to that the terminal device detects a publishing operation for the multimedia. Then, the terminal device may display the second form of the multimedia in response to the multimedia in the first form being triggered, and display the associated pages of the multimedia in response to that the multimedia in the second form is triggered.

The search authorization prompt indicates that the search function is enabled for the multimedia, and the search authorization prompt may include an authorization confirmation item and an authorization cancellation item. The search authorization prompt may further include a search authorization prompt text, for example, the search authorization prompt text may be “whether to enable the search function for the content, in response to that the search function for the content is enabled, it means that other users are authorized to search based on the content”, and a specific text content of the authorization prompt text is not limited in the embodiments of the present disclosure. During specific implementation, the confirmation information of the search authorization prompt is generated according to a detected trigger operation for the authorization confirmation item in response to that the terminal device receives the confirmation information of the search authorization prompt and enables the search function for the multimedia, that is, the terminal device may enable the search function for the multimedia based on the detected trigger operation for the authorization confirmation item; and the terminal device disenables the search function for the multimedia in response to that a trigger operation for the authorization cancellation item is detected.

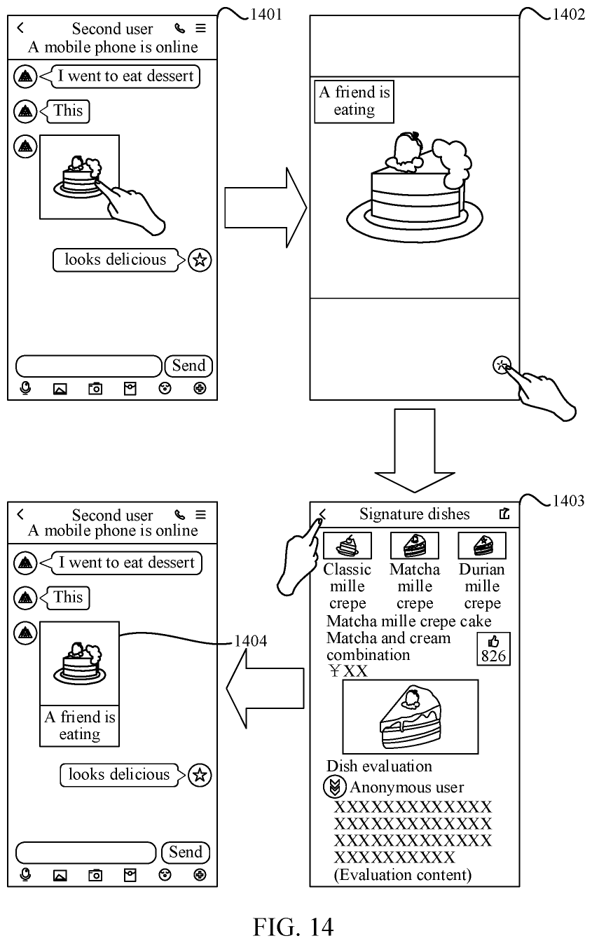

In an embodiment, the second form of the multimedia may be displayed based on the multimedia browsing window, the searched associated pages of the multimedia are characterized in response to that the multimedia in the second form is displayed in the terminal device, and the multimedia in the first form is updated and displayed as the multimedia in the second form in the social media page in response to that the multimedia browsing window is closed or the associated pages are closed. A way of displaying the multimedia in the second form based on updating the multimedia in the first form in the social media page may be the same as or different from a way of displaying the multimedia in the second form in the multimedia browsing window. For example, with reference to FIG. 14 which is a schematic diagram of an operation of displaying the multimedia in the second form in the social media page in an embodiment of the present disclosure, it is assumed that the social scenario is a social scenario where social session is performed, is specifically a social scenario for session between the first user and the second user, the social media page is the chat page in the social application, which may be shown as numeral 1401. The multimedia in the second form shown as numeral 1402 and displayed based on the multimedia browsing window includes an interaction label and an associated page trigger control, and an associated page of the multimedia are shown as numeral 1403. In response to that a target user closes the associated page, the multimedia in the second form displayed in the social media page may be shown as numeral 1404 and include an interaction label.

In the embodiments of the present disclosure, a multimedia in a first form is displayed in a social media page, wherein the first form indicates that the multimedia is in an unrecognized state. The multimedia is displayed in a second form in response to the multimedia in the first form being triggered, wherein the second form indicates that associated pages of the multimedia have been searched. The multimedia in the first form being triggered, which is described herein, means that the multimedia requires to further search relevant information, then, the multimedia in the first form can be recognized, associated pages can be searched based on a recognition result, and the multimedia is displayed in the second form to remind a user to view the searched associated pages. The associated pages are displayed in response to that the multimedia in the second form is triggered, so that the user can acquire more relevant information of the multimedia from the associated pages, and the efficiency and convenience of information acquisition in social scenarios can be effectively improved.

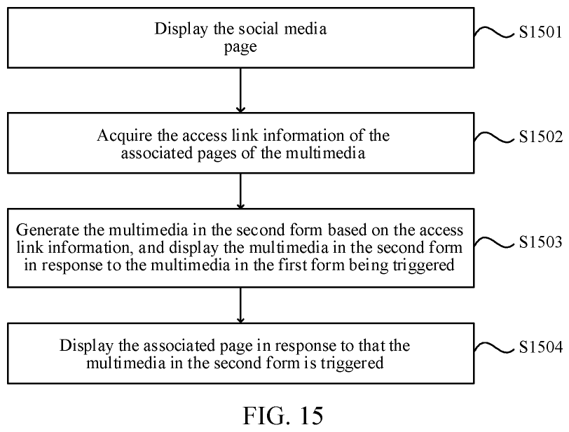

An embodiment of the present disclosure further provides another multimedia processing method based on the above-mentioned multimedia processing system and multimedia processing method. With reference to FIG. 15 which is a schematic flowchart of another multimedia processing method in an embodiment of the present disclosure, the multimedia processing method shown in FIG. 15 may be performed by a multimedia processing device which may be the terminal device in the multimedia processing system shown in FIG. 1, and the terminal device may independently complete corresponding processes of the multimedia processing method shown in FIG. 15; of course, the terminal device may also complete the corresponding processes of the multimedia processing method shown in FIG. 15 under the assistance of the server shown in FIG. 1. For facilitating description, the subsequent description is given with the terminal device being the terminal device of the first user, and the first user is any user using service provided by the social application. The multimedia processing method shown in FIG. 15 may include the following steps:

Step S1501: Display a social media page.

The social media page includes a multimedia, and the multimedia is displayed in a first form. The multimedia may be received by the terminal device and displayed in the social media page; and the multimedia may be published by the first user based on the social application or published by any social friend of the first user based on the social application. The process of S1502 is consistent with that of above-mentioned S201, the descriptions thereof are not to be repeated herein.

Step S1502: Acquire access link information of the associated pages of the multimedia.

The access link information includes access paths of the associated pages. The terminal device may access the associated pages of the multimedia based on the access paths of the associated pages and display the associated pages. In response to that the associated pages of the multimedia are mini application pages in the social application, the access paths of the associated pages are access paths of the mini application pages (i.e., miniAPPPath which is short for miniApplicationPath), and in some embodiments, the access link information of the associated pages may further include a mini application name (i.e., miniAPPId which is short for miniApplicationIdentity document). In response to that the associated pages of the multimedia are service pages in other applications than the social application, the access paths of the associated pages are access paths of the service pages in other applications, and in some embodiments, the access link information of the associated page may further include names of other applications. In response to that the associated pages of the multimedia are webpages, the access paths of the associated pages are access paths of the webpages, i.e., websites of the webpages. The embodiments of the present disclosure are all introduced with an example in which the associated pages are the mini application pages in the social application.

In an embodiment, the terminal device may acquire the access link information of the associated pages of the multimedia in a way of performing multi-dimensional recognition processing on the multimedia to obtain key information corresponding to the multimedia; and searching the access link information of the mini application pages matched with the multimedia from a database based on the key information corresponding to the multimedia.

During specific implementation, the terminal device may perform multi-dimensional recognition processing on the multimedia to obtain key information corresponding to the multimedia in a way of performing multi-dimensional recognition processing on the multimedia based on a deep learning technology and a search query technology to obtain initial key information corresponding to the multimedia; and performing data analysis and processing on the initial key information corresponding to the multimedia to obtain the key information corresponding to the multimedia. The key information corresponding to the multimedia indicates characteristics of the multimedia content included in the multimedia and may include one or more keywords. In some embodiments, the multi-dimensional recognition processing for the multimedia may include multi-dimensional recognition processing for the multimedia and auxiliary information carried by the multimedia, for example, the auxiliary information may be position information carried by the multimedia.

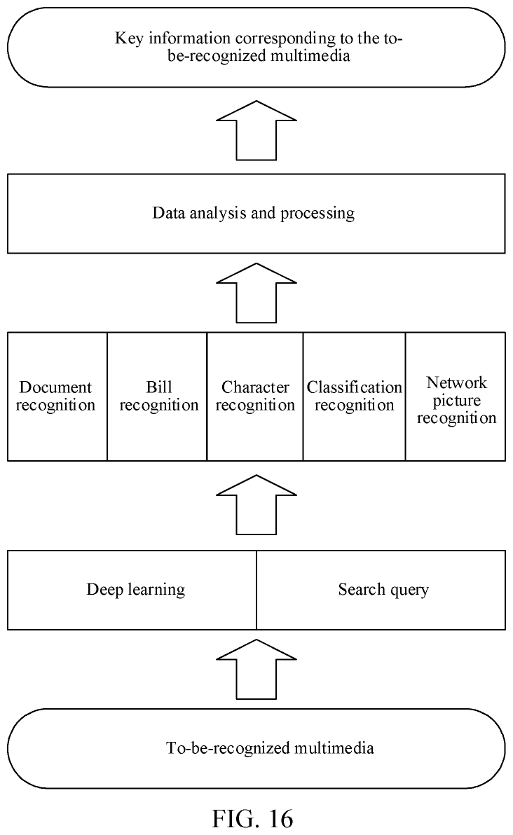

With reference to FIG. 16 which is a schematic diagram of multi-dimensional recognition processing on the multimedia in an embodiment of the present disclosure, the terminal device performs multi-dimensional recognition processing on the multimedia based on a deep learning technology and a search query technology to obtain initial key information corresponding to the multimedia. A plurality of dimensions may include a document recognition dimension, a bill recognition dimension, a character recognition dimension, a classification recognition dimension, a network picture recognition dimension, etc. The initial key information corresponding to the multimedia may include key information corresponding to the multimedia under the various dimensions, and the key information corresponding to the multimedia under one dimension may include one or more keywords corresponding to the multimedia under the dimension. Further, the terminal device performs data analysis and processing on the initial key information corresponding to the multimedia to obtain the key information corresponding to the multimedia, which may be that the corresponding key information under each dimension is determined as the key information corresponding to the multimedia. The terminal device performs data analysis and processing on the initial key information corresponding to the multimedia to obtain the key information corresponding to the multimedia, which may also be that the corresponding key information under one of the plurality of dimensions is determined as the key information corresponding to the multimedia, and the dimension may be determined randomly or according to a certain strategy. For example, in response to that the multimedia is an image, key information under a network picture dimension may be determined as key information corresponding to the image; and in response to that the multimedia is a text, key information under the character recognition dimension may be determined as key information of the text. The key information corresponding to the multimedia, obtained by performing data analysis and processing on the initial key information corresponding to the multimedia by the terminal device, may also be a preset number of keywords sequentially selected from corresponding key information under all the dimensions according to a number of statistics of the keywords from high to low, the preset number may be set according to specific requirements, for example, the preset number may be 3; and in response to that the corresponding key information under all the dimensions is sequentially a keyword 1, a keyword 2, a keyword 3, a keyword 4 and a keyword 5 according to the number of statistics of the keywords from high to low, and the preset number is 3, the determined key information corresponding to the multimedia includes the keyword 1, the keyword 2, and the keyword 3. In some embodiments, the key information corresponding to the multimedia, obtained by performing data analysis and processing on the initial key information corresponding to the multimedia by the terminal device, may also be obtained by performing data analysis and processing on the initial key information corresponding to the multimedia based on other data analysis strategies. In some embodiments, in response to that the multimedia is a video, multi-dimensional recognition processing may be performed based on a frame image of the video; and in response to that the multimedia is an audio, the audio is converted into a text firstly, and then, multi-dimensional recognition processing is performed based on the text.

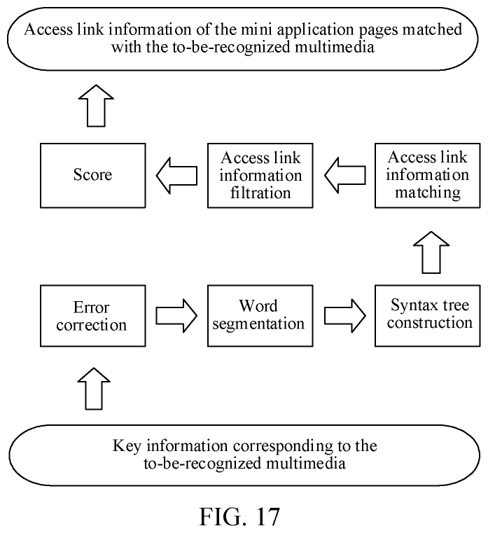

After obtaining the key information corresponding to the multimedia, the terminal device may search the access link information of the mini application pages matched with the multimedia from a database based on the key information corresponding to the multimedia. The access link information is maintained in the database based on the keywords, one keyword corresponds to one or more pieces of access link information, and one piece of access link information points to one mini application page. With reference to FIG. 17 which is a schematic diagram of confirmation of access link information in an embodiment of the present disclosure, the terminal device may sequentially perform error correction, word segmentation, syntax tree construction, access link information matching, access link information filtration and scoring on the key information of the multimedia to obtain the access link information of the mini application pages matched with the multimedia. By sequentially performing error correction and word segmentation on the key information of the multimedia, one or more to-be-processed keywords may be obtained, each of the one or more to-be-processed keywords is the keyword included in the database, and then, the one or more pieces of access link information corresponding to each of the to-be-processed keywords may be obtained based on operations such as syntax tree construction and access link information matching performed on each of the to-be-processed keywords. The access link information filtration is performed on the one or more pieces of access link information corresponding to each of the to-be-processed keywords to obtain a certain amount of candidate access link information. The candidate access link information may be a certain amount of candidate access link information sequentially determined from the access link information corresponding to all the to-be-processed keywords according to a number of statistics of the access link information from high to low, and the amount of the candidate access link information may be set according to specific requirements, for example, the amount may be 3. Further, each piece of candidate access link information is scored, the candidate access link information with the highest score is determined as the access link information matched with the multimedia, and the mini application pages pointed by the access link information matched with the multimedia are the associated pages of the multimedia. In some embodiments, a plurality of pieces of access link information matched with the multimedia may be determined based on a score of each piece of candidate access link information, and the mini application pages corresponding to the plurality of pieces of access link information matched with the multimedia are the plurality of associated pages of the multimedia. For example, the first two pieces of candidate access link information with scores being sorted from high to low may be determined as the plurality of pieces of access link information matched with the multimedia.

In an embodiment, the terminal device may call associated page search service provided by the server to acquire access link information, returned by the server of the associated pages of the multimedia. During specific implementation, the terminal device may send an associated page search request for searching the associated pages of the multimedia to the server, wherein the associated page search request carries the multimedia; after receiving the associated page search request, the server performs multi-dimensional recognition processing on the multimedia to obtain the key information corresponding to the multimedia, searches the access link information of the mini application pages matched with the multimedia from the database based on the key information corresponding to the multimedia, and returns the access link information to the terminal device. A relevant process that the server acquires the access link information of the mini application pages matched with the multimedia is similar to the above-mentioned relevant process that the terminal device acquires the access link information of the mini application pages matched with the multimedia, the descriptions thereof are not to be repeated herein.

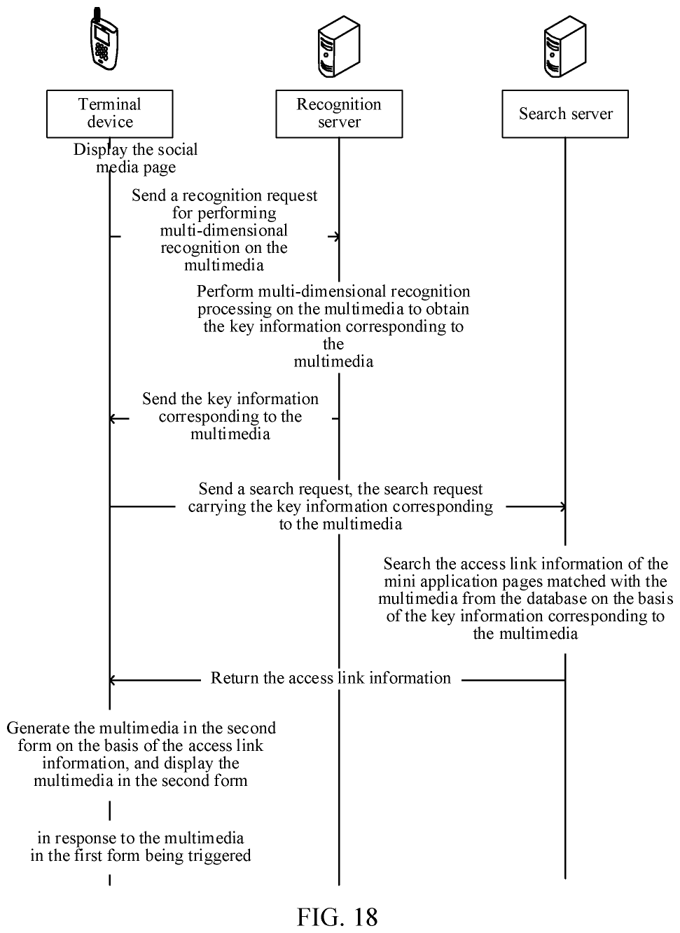

In an embodiment, with reference to FIG. 18 which is a schematic diagram of acquisition of the access link information of the associated pages based on a server in an embodiment of the present disclosure, the terminal device may respectively call recognition service provided by a recognition server and search service provided by a search server to implement for the access link information of the associated pages of the multimedia. During specific implementation, the terminal device may send a recognition request for performing multi-dimensional recognition on the multimedia to the recognition server, wherein the recognition request carries the multimedia; after receiving the recognition request, the recognition server performs multi-dimensional recognition processing on the multimedia to obtain the key information corresponding to the multimedia, and sends the key information corresponding to the multimedia to the terminal device; after receiving the key information corresponding to the multimedia and sent by the recognition server, the terminal device may send a search request for searching the access link information of the associated pages of the multimedia based on the key information corresponding to the multimedia to the search server, wherein the search request carries the key information corresponding to the multimedia; and after receiving the key information corresponding to the multimedia, the search server may search the access link information of the mini application pages matched with the multimedia from the database based on the key information corresponding to the multimedia, and return the access link information to the terminal device. Further, the terminal device generates the multimedia in the second form based on the access link information, and displays the multimedia in the second form in response to the multimedia in the first form being triggered.

Step S1503: Generate the multimedia in the second form based on the access link information, and display the multimedia in the second form in response to the multimedia in the first form being triggered.

The second form indicates that associated pages of the multimedia have been searched.

In an embodiment, the terminal device may generate the multimedia in the second form based on the access link information in a way of adding the access link information into the multimedia in the first form to generate the multimedia in the second form. Therefore, the associated pages are accessed according to the access link information and are displayed in response to that the multimedia in the first form is triggered.

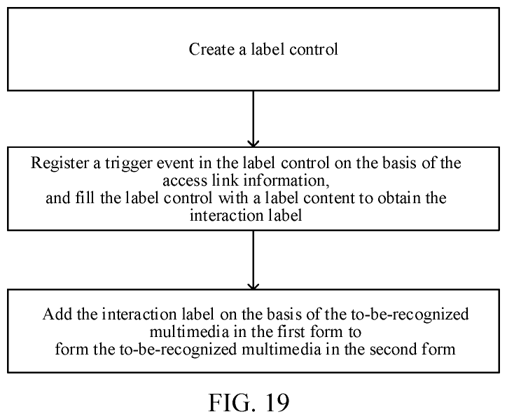

In an embodiment, with reference to FIG. 19 which is a schematic diagram of an operation of displaying the multimedia in the second form based on a label control in an embodiment of the present disclosure, in response to that the multimedia in the second form includes an interaction label, the terminal device may generate the multimedia in the second form based on the access link information in a way of creating a label control, registering a trigger event in the label control based on the access link information, and filling the label control with a label content to obtain the interaction label, and then, adding the interaction label based on the multimedia in the first form to form the multimedia in the second form. The trigger event indicates the access of the associated pages of the multimedia according to the access link information and the display of the associated pages based on a trigger operation for the label control (i.e., the subsequently generated interaction label). The trigger operation includes, but is not limited to a clicking operation, a pressing gesture operation, and a suspending gesture operation.

In an embodiment, in response to that the multimedia in the second form includes associated page trigger controls, the terminal device may generate the multimedia in the second form based on the access link information in a way of creating a button control, and registering a trigger event in the button control based on the access link information to obtain the associated page trigger controls, and then, adding the associated page trigger controls based on the multimedia in the first form to form the multimedia in the second form. The trigger event indicates the access of the associated pages of the multimedia according to the access link information and the display of the associated pages based on a trigger operation for the button control (i.e., the subsequently generated associated page trigger controls). The trigger operation includes, but is not limited to a clicking operation, a pressing gesture operation, and a suspending gesture operation.

Step S1504: Display the associated page in response to that the multimedia in the second form is triggered.

S1504 is consistent with above-mentioned S203, the descriptions thereof are not to be repeated herein.

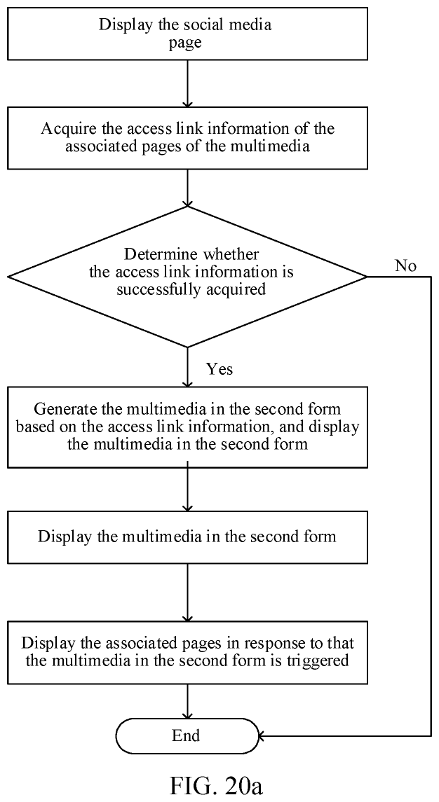

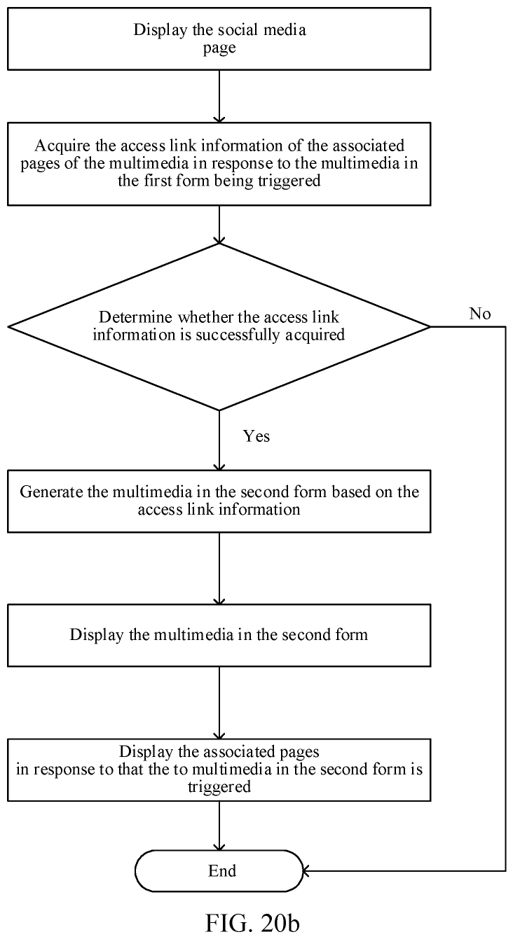

With reference to FIG. 20a which is a schematic diagram of an operation of displaying the associated pages based on acquiring the access link information of the associated pages in an embodiment of the present disclosure, the terminal device displays the social media page, and acquires the access link information of the associated pages of the multimedia. In response to that the terminal device successfully acquires the access link information, the multimedia in the second form is generated based on the access link information and is displayed in response to that the multimedia in the first form is triggered. The associated pages are displayed in response to that the multimedia in the second form is triggered. In response to that the terminal device fails to acquire the access link information, a multimedia in a demonstrated form is generated in response to that the multimedia in the first form is triggered, wherein the multimedia in the demonstrated form includes the multimedia, but does not carry the access link information, and the associated pages may not be displayed in response to that the multimedia in the demonstrated form is triggered.

In an embodiment, S1502 may be performed at any time after the terminal device receives the multimedia, which may be the time before the terminal device displays the first form of the multimedia in the social media page after receiving the multimedia, i.e., the time before S1501 is performed; or the time when the terminal device displays the first form of the multimedia in the social media page after receiving the multimedia, i.e., the time when S1501 is performed; or the time after the terminal device displays the first form of the multimedia in the social media page after receiving the multimedia, i.e., the time after S1501 is performed; or the time when the terminal device makes a response to the multimedia in the first form being triggered.

With reference to FIG. 20b which is a schematic diagram of another display of the associated pages based on acquiring the access link information of the associated pages in an embodiment of the present disclosure, the terminal device displays the social media page, and acquires the access link information of the associated pages of the multimedia in response to the multimedia in the first form being triggered. In response to that the terminal device successfully acquires the access link information, the multimedia in the second form is generated based on the access link information and is displayed. The associated pages are displayed in response to that the multimedia in the second form is triggered. In response to that the terminal device fails to acquire the access link information, a multimedia in a demonstrated form is generated in response to that the multimedia in the first form is triggered, wherein the multimedia in the demonstrated form does not carry the access link information, and the associated pages may not be displayed in response to that the multimedia in the demonstrated form is triggered.

In the embodiments of the present disclosure, the access link information of the associated pages of the multimedia may be acquired based on multi-dimensional recognition processing for the multimedia, then, the multimedia in the second form may be generated based on the access link information and displayed in response to the multimedia in the first form being triggered, and the associated pages are accessed based on the access link information and are displayed in response to that the multimedia in the second form is triggered. By searching and displaying the associated pages of the multimedia based on multi-dimensional recognition processing for the multimedia, the associated pages matched with the multimedia may be acquired on the basis that the multimedia is acquired, so that the efficiency of information acquisition in social scenarios can be improved.

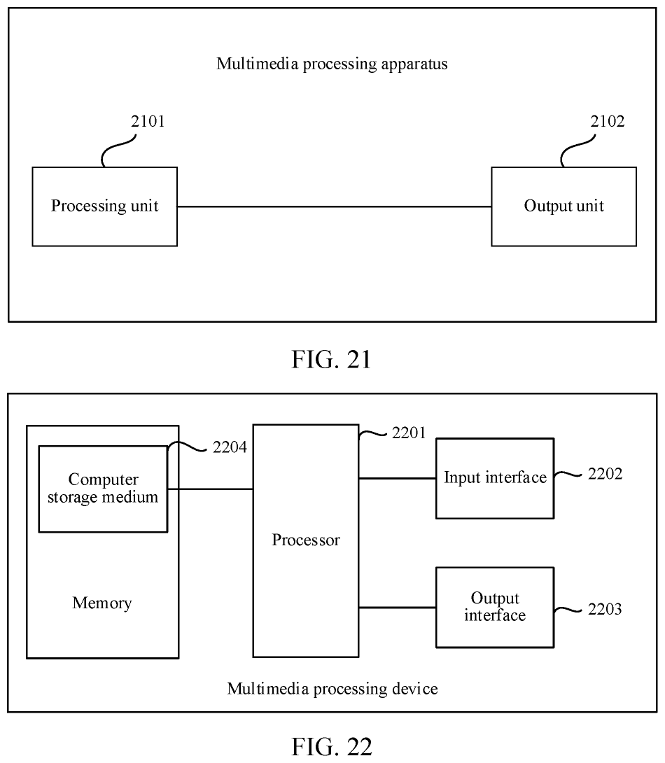

An embodiment of the present disclosure provides a multimedia processing apparatus based on the above-mentioned embodiments of the multimedia processing method. With reference to FIG. 21 which is a schematic structural diagram of a multimedia processing apparatus in an embodiment of the present disclosure, the multimedia processing apparatus may include a processing unit 2101 and an output unit 2102; the multimedia processing apparatus may be a computer program (including a program code) running in a multimedia processing device, for example, the multimedia processing device may be a terminal device, and thus, the multimedia processing apparatus may be a social application in the terminal device; and the multimedia processing apparatus may be configured to perform parts or all of steps in the embodiment of the method shown in FIG. 2 and FIG. 15. With reference to FIG. 21, the multimedia processing apparatus includes the following units:
the output unit 2102, configured to display a social media page, the social media page including a multimedia, the multimedia being displayed in a first form, and the first form indicating that the multimedia is in an unrecognized state;
the output unit 2102 is further configured to display the multimedia in a second form in response to the multimedia in the first form being triggered, the second form indicating that associated pages of the multimedia have been searched, and page contents of the associated pages being matched with a multimedia content of the multimedia; and
the output unit 2102 is further configured to display the associated pages in response to that the multimedia in the second form is triggered.

In an embodiment, the social media page refers to any service page in a social application; and the associated pages include any one shown as follows: a mini application page in the social application, service pages in other applications than the social application, and a webpage;
the second form of the multimedia further indicates that the multimedia is in a recognized state.

In an embodiment, the output unit 2102 displays the associated pages in response to that the multimedia in the second form is triggered, which is specifically performed according to the following operation:
display the associated pages in response to that a trigger operation is performed on the multimedia in the second form;
wherein the trigger operation includes any one shown as follows: a clicking operation, a pressing gesture operation, and a suspending gesture operation.

In an embodiment, the multimedia in the second form includes an interaction label indicating a presence of a social friend associated with the multimedia;
wherein the interaction label is displayed in the multimedia in the second form in any one of the following ways that: the interaction label is displayed on any position in the multimedia in the second form; or, the interaction label is displayed in a suspended way in the multimedia in the second form; or, the interaction label is displayed around the multimedia in the second form; or, the interaction label defaults to be hidden and is only displayed in response to that a staying signal exists in the multimedia in the second form; and
the interaction label includes any one shown as follows: a prompt text, a prompt animation, and identity information of the social friend; and the identity information including es any one shown as follows: a nickname, a logo, and a head portrait.

In an embodiment, the output unit 2102 displays the associated pages in response to that the multimedia in the second form is triggered, which is specifically performed according to the following operation:
display the associated pages in response to that a trigger operation is performed on the interaction label;
wherein the trigger operation includes any one shown as follows: a clicking operation, a pressing gesture operation, and a suspending gesture operation.

In an embodiment, the multimedia in the second form includes associated page trigger controls, and the output unit 2102 displays the associated pages in response to that the multimedia in the second form is triggered, which is specifically performed according to the following operation:
display the associated pages in response to that a trigger operation is performed on the associated page trigger controls;
wherein the associated page trigger controls are displayed in the multimedia in the second form in any one of the following ways that: the associated page trigger controls are displayed on any positions in the multimedia in the second form; or, the associated page trigger controls are displayed in a suspended way in the multimedia in the second form; or, the associated page trigger controls are displayed around the multimedia in the second form; or, the associated page trigger controls default to be hidden and are only displayed in response to that a staying signal exists in the multimedia in the second form.

In an embodiment, the multimedia has a plurality of associated pages;
the output unit 2102 displays the associated pages in response to that a trigger operation is performed on the associated page trigger controls, which is specifically performed according to the following operation:
display a candidate list in response to that the trigger operation is performed on the associated page trigger controls, the candidate list including a plurality of candidates of the associated pages; different candidates of the associated pages in the plurality of candidates of the associated pages being used to trigger the display of different associated pages of the multimedia; and
display an associated page indicated by a selected candidate of the associated pages in response to that any one of the candidates of the associated pages in the candidate list is selected.

In an embodiment, the multimedia has a plurality of associated pages, the multimedia in the second form includes a plurality of associated page trigger controls, and each of the associated page trigger controls is used to trigger the display of one of the associated pages of the multimedia;
the output unit 2102 displays the associated pages in response to that the multimedia in the second form is triggered, which is specifically performed according to the following operation:
display an associated page indicated by a triggered associated page trigger control in response to that any one of the plurality of associated page trigger controls is triggered;
wherein the plurality of associated page trigger controls are displayed in the multimedia in the second form in any one of the following ways that: the associated page trigger controls are displayed in a randomly distributed way in the multimedia in the second form; the associated page trigger controls are displayed in an orderly arranged way in the multimedia in the second form; the associated page trigger controls are displayed around the multimedia in the second form.

In an embodiment, in response to that the output unit 2102 displays the multimedia in the second form in response to the multimedia in the first form being triggered, an operation is specifically performed as follows:
output a multimedia browsing window in response to the multimedia in the first form being triggered; and
display the multimedia in the second form in the multimedia browsing window.

In an embodiment, the output unit 2102 is further configured to update and display the multimedia in the first form as the multimedia in the second form in the social media page in response to that the multimedia browsing window is closed or the associated pages are closed.

In an embodiment, the social media page is a chat page in the social application, the chat page includes a chat message, and the chat message includes the multimedia in the first form; or
the social media page is a friend news page in the social application, the friend news page includes a news message, and the news message includes the multimedia in the first form; or
the social media page is a state query page of the social friend in the social application, the state query page includes a state content published by the social friend, and the state content includes the multimedia in the first form; or
the social media page is a topic page in the social application, and the topic page includes the multimedia in the first form.

In an embodiment, the associated pages are searched after a search function is enabled for the multimedia; and the output unit 2102 is further configured to: output a search authorization prompt in response to that the multimedia to be published to the social media page is detected, the search authorization prompt indicating that the search function is enabled for the multimedia; and
the processing unit 2101 is further configured to enable the search function for the multimedia in response to that confirmation information of the search authorization prompt is received.

In an embodiment, the associated pages include a mini application page in a social application; and the processing unit 2101 is further configured to acquire access link information of the associated pages of the multimedia, the access link information including a mini application name and an access path of the mini application page;
the processing unit 2101 displays the multimedia in a second form in response to the multimedia in the first form being triggered, which is specifically performed according to the following operation:
generate the multimedia in the second form based on the access link information, and display the multimedia in the second form in response to the multimedia in the first form being triggered.

In an embodiment, in response to that the processing unit 2101 acquires the access link information of the associated pages of the multimedia, an operation is specifically performed as follows:
perform multi-dimensional recognition processing on the multimedia to obtain key information corresponding to the multimedia; and
search the access link information of the mini application page matched with the multimedia from a database based on the key information corresponding to the multimedia.

In an embodiment, in response to that the processing unit 2101 generates the multimedia in the second form based on the access link information, an operation is specifically performed as follows:
add the access link information into the multimedia in the first form to generate the multimedia in the second form.

In an embodiment, in response to that the processing unit 2101 generates the multimedia in the second form based on the access link information, an operation is specifically performed as follows:
create a label control;
register a trigger event in the label control based on the access link information, and fill the label control with a label content to obtain the interaction label; and
add the interaction label based on the multimedia in the first form to form the multimedia in the second form.

In an embodiment, in response to that the processing unit 2101 generates the multimedia in the second form based on the access link information, an operation is specifically performed as follows:
create a button control, and registering a trigger event in the button control based on the access link information to obtain the associated page trigger controls; and
add the associated page trigger controls based on the multimedia in the first form to form the multimedia in the second form.

According to an embodiment of the present disclosure, all the steps involved in the multimedia processing method shown in FIG. 2 and FIG. 15 may be performed by each unit in the multimedia processing apparatus shown in FIG. 21. For example, S201 to S203 shown in FIG. 2 may be performed by the output unit 2103 in the multimedia processing apparatus shown in FIG. 21; and for another example, S1501 and S1504 shown in FIG. 15 may be performed by the output unit 2102 in the multimedia processing apparatus shown in FIG. 21, S1502 shown in FIG. 15 may be performed by the processing unit 2101 in the multimedia processing apparatus shown in FIG. 21, and S1503 shown in FIG. 15 may be performed jointly by the processing unit 2101 and the output unit 2102 in the multimedia processing apparatus shown in FIG. 21.

According to another embodiment of the present disclosure, all the units in the multimedia processing apparatus shown in FIG. 21 may be respectively or all combined into one or more other units, or a certain (some) unit may be further split into a plurality of units having less functions, which may achieve the same operation without affect the implementation of technical effects of the embodiments of the present disclosure. The above-mentioned units are divided based on logic functions, and during actual applications, a function of a unit may also be achieved by a plurality of units, or functions of a plurality of units are achieved by one unit. In other embodiments of the present disclosure, the multimedia processing apparatus divided based on the logic functions may further include other units, and during actual applications, these functions may also be achieved under the assistance of other units and may be achieved by the cooperation of the plurality of units.

According to further embodiment of the present disclosure, by running the computer program (including the program code) capable of performing all the steps involved in the corresponding method shown in FIG. 2 or FIG. 15 on a general-purpose computing device such as a computer including a processing unit and a storage element such as a central processing unit (CPU), a random access memory (RAM), and a read-only memory (ROM), the multimedia processing apparatus shown in FIG. 21 may be structured, and the multimedia processing method in the embodiments of the present disclosure may be implemented. The computer program may be recorded on, for example, a computer readable storage medium, may be loaded in the above-mentioned computing device by the computer readable storage medium, and may run therein.

In the embodiments of the present disclosure, a multimedia in a first form is displayed in a social media page, wherein the first form indicates that the multimedia is in an unrecognized state. The multimedia is displayed in a second form in response to the multimedia in the first form being triggered, wherein the second form indicates that associated pages of the multimedia have been searched. The multimedia in the first form being triggered, which is described herein, means that the multimedia requires to further search relevant information, then, the multimedia in the first form can be recognized, associated pages can be searched based on a recognition result, and the multimedia is displayed in the second form to remind a user to view the searched associated pages. The associated pages are displayed in response to that the multimedia in the second form is triggered, so that the user can acquire more relevant information of the multimedia from the associated pages, and the efficiency and convenience of information acquisition in social scenarios can be effectively improved.

The present disclosure further provides a multimedia processing device based on the above-mentioned embodiments of the multimedia processing method and apparatus. With reference to FIG. 22 which is a schematic structural diagram of a multimedia processing device in an embodiment of the present disclosure, the multimedia processing device shown in FIG. 22 may at least include a processor 2201, an input interface 2202, an output interface 2203, and a computer storage medium 2204, wherein the processor 2201, the input interface 2202, the output interface 2203 and the computer storage medium 2204 may be connected by a bus or in other ways.

The computer storage medium 2204 may be stored in a memory of the multimedia processing device and is configured to have stored thereon a computer program including a program instruction, and the processor 2201 is configured to execute the program instruction stored in the computer storage medium 2204. The processor 2201 (or referred to as central processing unit (CPU)) is a computing core and a control core of the multimedia processing device, is suitable for implementing one or more instructions, and is specifically suitable for loading and executing one or more instructions, thereby achieving the processes or corresponding functions of the above-mentioned multimedia processing method.

An embodiment of the present disclosure further provides a computer storage medium (Memory) which is a memory device in the multimedia processing device and is configured to have stored thereon programs and data. It is to be understood that the computer storage device described herein may include a built-in storage medium in a terminal, of course, it may also include an expanded storage medium supported by the terminal. The computer storage medium provides a storage space in which an operating system of the terminal is stored. Moreover, one or more instructions suitable for being loaded and executed by the processor 2201 are further stored in the storage space, and these instructions may be one or more computer programs (including program codes). The computer storage medium described herein may be a high-speed random access memory (RAM) or a non-volatile memory, such as at least one disk memory; and in some embodiments, it may also be at least one a computer storage medium away from the above-mentioned processor.

In an embodiment, the multimedia processing device may be the terminal device mentioned in the above-mentioned embodiments; one or more instructions stored in the computer storage medium may be loaded and executed by the processor 2201 and the output interface 2203, and the one or more instructions in the computer storage medium are loaded and executed by the processor 2201 and the output interface 2203 to implement the corresponding steps of the method in the embodiment of the multimedia processing method in FIG. 2 and FIG. 15.

An embodiment of the present disclosure provides a computer program product or a computer program, the computer program product includes a computer program, and the computer program is stored in a computer storage medium; a processor of a multimedia processing device reads the computer program from the computer storage medium, and the processor executes the computer program to enable the multimedia processing device to perform the embodiment of the method shown in FIG. 2 and FIG. 15. The computer readable storage medium may be a diskette, an optical disk, a read-only memory (ROM), or a random access memory (RAM), etc.

The above descriptions are merely specific implementations of the present disclosure, but the protection scope of the present disclosure is not limited thereto. Any variations or replacements that can be readily envisioned by those skilled in the art within the technical scope disclosed by the present disclosure are to fall within the protection scope of the present disclosure. Therefore, the protection scope of the present application shall be subject to the appended claims.

What is claimed is:

1. A multimedia processing method, performed by a computer device, and comprising:
displaying a social media page, the social media page comprising a multimedia displayed in a first form, and the first form indicating that the multimedia is in an unrecognized state;
displaying the multimedia in a second form in response to the multimedia in the first form being triggered, the second form indicating that an associated page of the multimedia has been searched, and page content of the associated page being matched with a multimedia content of the multimedia; and
displaying the associated page in response to that the multimedia in the second form is triggered.

2. The method of claim 1, wherein the social media page refers to a service page in a social application; and the associated page comprises at least one of: a mini application page in the social application, a service page in an application other than the social application, or a webpage;
the second form further indicates that the multimedia is in a recognized state.

3. The method of claim 1, wherein the displaying the associated page in response to that the multimedia in the second form is triggered comprises:
displaying the associated page in response to that a trigger operation is performed on the multimedia in the second form;
wherein the trigger operation comprises one of: a clicking operation, a pressing gesture operation, or a suspending gesture operation.

4. The method of claim 1, wherein the multimedia in the second form comprises an interaction label indicating a presence of a social friend associated with the multimedia;
wherein the interaction label is displayed in the multimedia in the second form by: displaying on a position within the multimedia in the second form; or, displaying in a suspended way in the multimedia in the second form; or, displaying around the multimedia in the second form; or, hiding the interaction label by default and only displaying the interaction label in response to that a staying signal exists in the multimedia in the second form; and
the interaction label comprises at least one of: a prompt text, a prompt animation, and identity information of the social friend; and the identity information comprises at least one of: a nickname, a logo, or a head portrait.

5. The method of claim 4, wherein the displaying the associated page in response to that the multimedia in the second form is triggered comprises:
displaying the associated page in response to that a trigger operation is performed on the interaction label; wherein the trigger operation comprises one of: a clicking operation, a pressing gesture operation, and a suspending gesture operation.

6. The method of claim 1, wherein the multimedia in the second form comprises an associated page trigger control, and the displaying the associated page in response to that the multimedia in the second form is triggered comprises:
displaying the associated page in response to that a trigger operation is performed on the associated page trigger control;
wherein the associated page trigger control is displayed in the multimedia in the second form by: displaying on a position within the multimedia in the second form; or, displaying in a suspended way in the multimedia in the second form; or, displaying around the multimedia in the second form; or, hiding the associated page trigger control by default and only displaying hiding the associated page trigger control in response to that a staying signal exists in the multimedia in the second form.

7. The method of claim 6, wherein the multimedia has a plurality of associated pages;
the displaying the associated page in response to that a trigger operation is performed on the associated page trigger controls comprises:
displaying a candidate list in response to that the trigger operation is performed on the associated page trigger control, the candidate list comprising a plurality of candidates of the associated pages; different candidates being configured to trigger the display of different associated pages of the multimedia; and
displaying an associated page indicated by a selected candidate of the associated pages in response to that one of the candidates of the associated page in the candidate list is selected.

8. The method of claim 1, wherein the multimedia has a plurality of associated pages, the multimedia in the second form comprises a plurality of associated page trigger controls, and each of the associated page trigger controls is configured to trigger the display of one of the associated pages of the multimedia;
the displaying the associated page in response to that the multimedia in the second form is triggered comprises:
displaying an associated page indicated by a triggered associated page trigger control in response to that one of the plurality of associated page trigger controls is triggered;
wherein the plurality of associated page trigger controls are displayed by: displaying in a randomly distributed way in the multimedia in the second form; or displaying in an orderly arranged way in the multimedia in the second form; or displaying around the multimedia in the second form.

9. The method of claim 1, wherein the displaying the multimedia in a second form in response to the multimedia in the first form being triggered comprises:
outputting a multimedia browsing window in response to the multimedia in the first form being triggered; and
displaying the multimedia in the second form in the multimedia browsing window.

10. The method of claim 9, further comprising:
updating and displaying the multimedia in the social media page from the first form to the second form in response to that the multimedia browsing window is closed or the associated page are closed.

11. The method of claim 1, wherein the social media page is a chat page in the social application, the chat page comprises a chat message, and the chat message comprises the multimedia in the first form; or
the social media page is a friend news page in the social application, the friend news page comprises a news message, and the news message comprises the multimedia in the first form; or
the social media page is a state query page of the social friend in the social application, the state query page comprises a state content published by the social friend, and the state content comprises the multimedia in the first form; or
the social media page is a topic page in the social application, and the topic page comprises the multimedia in the first form.

12. The method of claim 1, further comprising:
outputting a search authorization prompt in response to that the multimedia to be published to the social media page is detected, the search authorization prompt indicating that the search function is enabled for the multimedia; and
enabling the search function for the multimedia in response to that confirmation information of the search authorization prompt is received.

13. The method of claim 1, wherein the associated page comprise a mini application page in a social application; and the method further comprises:
acquiring access link information of the associated page of the multimedia, the access link information comprising a mini application name and an access path of the mini application page;
the displaying the multimedia in a second form in response to the multimedia in the first form being triggered comprises:
generating the multimedia in the second form based on the access link information, and displaying the multimedia in the second form in response to the multimedia in the first form being triggered.

14. The method of claim 13, wherein the acquiring access link information of the associated page of the multimedia comprises:
performing multi-dimensional recognition processing on the multimedia to obtain key information corresponding to the multimedia; and
searching the access link information of the mini application page matched with the multimedia from a database based on the key information.

15. The method of claim 13, wherein the generating the multimedia in the second form based on the access link information comprises:
adding the access link information into the multimedia in the first form to generate the multimedia in the second form.

16. The method of claim 13, wherein the generating the multimedia in the second form based on the access link information comprises:
creating a label control;
registering a trigger event in the label control based on the access link information, and filling the label control with a label content to obtain the interaction label; and
adding the interaction label based on the multimedia in the first form to form the multimedia in the second form.

17. The method of claim 13, wherein the generating the multimedia in the second form based on the access link information comprises:
creating a button control, and registering a trigger event in the button control based on the access link information to obtain the associated page trigger controls; and
adding the associated page trigger controls based on the multimedia in the first form to form the multimedia in the second form.

18. A multimedia processing apparatus, comprising:
at least one processor configured to implement one or more instructions; and
at least one computer storage medium having stored thereon one or more instructions, and the one or more instructions being loaded and executed by the at least one processor to implement:
displaying a social media page, the social media page comprising a multimedia displayed in a first form, and the first form indicating that the multimedia is in an unrecognized state;
displaying the multimedia in a second form in response to the multimedia in the first form being triggered, the second form indicating that an associated page of the multimedia has been searched, and page content of the associated page being matched with a multimedia content of the multimedia; and
displaying the associated page in response to that the multimedia in the second form is triggered.

19. The apparatus of claim 18, wherein the social media page refers to a service page in a social application; and the associated page comprises at least one of: a mini application page in the social application, a service page in an application other than the social application, or a webpage; and the second form further indicates that the multimedia is in a recognized state.

20. A non-transitory computer storage medium having stored thereon a computer program instruction, and the computer program instruction, when being executed by at least one processor, causing the at least one processor to perform:
displaying a social media page, the social media page comprising a multimedia displayed in a first form, and the first form indicating that the multimedia is in an unrecognized state;
displaying the multimedia in a second form in response to the multimedia in the first form being triggered, the second form indicating that an associated page of the multimedia has been searched, and page content of the associated page being matched with a multimedia content of the multimedia; and
displaying the associated page in response to that the multimedia in the second form is triggered.
